(19) United States
(12) Patent Application Publication
(10) Pub. No.: US 2025/0068875 A1
(43) Pub. Date: Feb. 27, 2025

(54) STORAGE MEDIUM STORING APPLICATION PROGRAM THAT SUPPORTS GENERAL PURPOSE PRINTING SOFTWARE, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: MASATO KOBAYASHI, Chiba (JP)

(21) Appl. No.: 18/808,165

(22) Filed: Aug. 19, 2024

(30) Foreign Application Priority Data
Aug. 21, 2023 (JP) 2023-134130

(51) Int. Cl. G06K 15/02; G06F 3/12

(52) U.S. Cl. CPC G06K 15/1878; G06F 3/1205; G06F 3/1258

(57) ABSTRACT

A mechanism that causes an information processing apparatus to display a screen that accepts settings of color adjustment by executing an application program that supports general purpose printing software is provided. A non-transitory computer readable storage medium stores an application program that supports general purpose printing software capable of generating print data printable by printing apparatuses provided by a plurality of manufacturers and causing to transmit the generated print data to the printing apparatus. The application program is executed by an information processing apparatus so that a control method is executed. The control method includes causing the information processing apparatus to display a screen that accepts settings for color adjustments from a user, and causing the printing apparatus to execute color adjustments of print data generated by the general purpose printing software based on the settings that have been accepted via the screen.

### BACKGROUND OF THE INVENTION

### Field of the Invention

The present invention relates to a storage medium storing an application program that supports general purpose printing software, a control method for an information processing apparatus, and an information processing apparatus.

### Description of the Related Art

Conventionally, a configuration has been known in which a printer driver is installed into a host computer as control software for a printing apparatus, and the printer driver is used to issue a printing instruction to the printing apparatus connected to the host computer.

An operating system (hereinafter, referred to as “an OS”), which is basic software, has been installed into the host computer, and the printer driver is configured in accordance with the specifications defined by the OS and is invoked by the OS to operate. By providing a user of the host computer with a printer driver that conforms to the specifications of the OS, a manufacturer that provides the printing apparatus is able to provide the user with a means for instructing the printing apparatus to print by using the OS on the host computer.

In recent years, Windows (registered trademark) has provided general purpose printing software (hereinafter, also referred to as “a standard driver”) that is capable of being used in common for printing apparatuses provided by a plurality of manufacturers. Such a standard driver is bundled with the package of the OS, and simply by connecting any printing apparatus to the host computer, it becomes possible to immediately issue a printing instruction from the host computer to the any printing apparatus. This eliminates the need to separately install a model-specific printer driver suitable for the printing apparatus, which is highly convenient. In addition, the standard driver is configured so that print functions can be designated according to print device capabilities (hereinafter, referred to as “PDC”) generated based on information obtained from the connected printing apparatus. As a result, the user who uses the standard driver is able to designate the print functions according to the capabilities of the connected printing apparatus, even though the user uses only one standard driver. However, the print functions that can be designated in this case are limited to simple functions that can be realized only by the standard driver. For this reason, there are manufacturer's unique functions that can be executed by the printing apparatus connected to the host computer, but cannot be realized with the standard driver.

Therefore, Japanese Laid-Open Patent Publication (kokai) No. 2021-33526 has disclosed a technique for extending the functions of the standard driver by using an extended application for the standard driver so as to be able to realize the manufacturer's unique functions.

Here, as the manufacturer's unique functions, there are color adjustment functions. The color adjustment functions include, for example, brightness adjustment for adjusting the brightness of print data, saturation adjustment for adjusting the saturation (vividness) of the print data, hue adjustment for adjusting the color tone of the print data, and contrast adjustment for adjusting the contrast of the print data. It is possible to adjust them individually or in combination with each other. As a result, it is possible to print the print data in the user's preferred color.

However, although the extended application disclosed in Japanese Laid-Open Patent Publication (kokai) No. 2021-33526 is able to realize a double-sided printing function, a bookbinding printing function, etc., when printing using the standard driver, it is not able to realize the color adjustment functions. On the other hand, in the case that it is not possible to use the color adjustment functions when printing, the user is not able to adjust the print data to the intended color, which causes inconvenience to the user.

### SUMMARY OF THE INVENTION

The present invention provides a mechanism that causes an information processing apparatus to display a screen that accepts settings of color adjustment by executing an application program that supports general purpose printing software.

Accordingly, the present invention provides a non-transitory computer readable storage medium storing an application program that supports general purpose printing software capable of generating print data printable by printing apparatuses provided by a plurality of manufacturers and causing to transmit the generated print data to the printing apparatus, the application program being executed by an information processing apparatus so that a control method is executed, the control method comprising causing the information processing apparatus to display a screen that accepts settings for color adjustments from a user, and causing the printing apparatus to execute color adjustments of print data generated by the general purpose printing software based on the settings that have been accepted via the screen.

According to the present invention, it is possible to cause the information processing apparatus to display the screen that accepts the settings of the color adjustment by executing the application program that supports the general purpose printing software.

Further features of the present invention will become apparent from the following description of exemplary embodiments with reference to the attached drawings.

### BRIEF DESCRIPTION OF THE DRAWINGS

FIG. 1 is a block diagram that shows a hardware configuration of a host computer as an information processing apparatus according to a first embodiment.

FIG. 2A is a diagram for explaining a software configuration of a conventional printing system, and FIG. 2B is a diagram for explaining a software configuration of a printing system according to the first embodiment.

FIGS. 3A, 3B, 3C, 3D, and 3E are diagrams that show examples of print setting screens displayed by a print setting extending unit shown in FIG. 2B.

FIG. 4 is a flowchart of a PDC editing processing according to the first embodiment executed by a print function extending unit.

FIG. 5 is a diagram that shows an example of capability information obtained by the host computer from a printing apparatus in the first embodiment.

FIG. 6 is a diagram that shows an example of print functions supported by an extended application shown in FIG. 2B and setting values thereof.

FIG. 7 is a diagram that shows an example of print functions supported by general purpose printing software shown in FIG. 2B and setting values thereof.

FIG. 8 is a sequence diagram of a printing processing according to the first embodiment executed by an editing application, the general purpose printing software, the extended application, and the printing apparatus after the editing application accepts a print setting.

FIG. 9 is a diagram for explaining a software configuration of a printing system according to a second embodiment.

FIG. 10 is a flowchart of a PDC editing processing according to the second embodiment executed by a print function extending unit.

FIG. 11 is a diagram that shows an example of capability information obtained by the host computer from a printing apparatus in the second embodiment.

FIG. 12 is a sequence diagram of a printing processing according to the second embodiment executed by the editing application, the general purpose printing software, an extended application, and the printing apparatus after the editing application accepts a print setting.

FIG. 13A is a diagram that shows an example of a tone curve for brightness adjustment in the present invention, and FIG. 13B is a diagram that shows an example of a tone curve for contrast adjustment in the present invention.

FIG. 14 is a sequence diagram of a printing processing according to a third embodiment executed by the editing application, the general purpose printing software, the extended application, and a printing apparatus after the editing application accepts a print setting.

FIG. 15 is a sequence diagram of a printing processing according to a fourth embodiment executed by the editing application, the general purpose printing software, the extended application, and the printing apparatus after the editing application accepts a print setting.

FIGS. 16A, 16B, and 16C are diagrams that show examples of detailed setting screens and a preview screen that are displayed by a print setting extending unit in the fourth embodiment.

### DESCRIPTION OF THE EMBODIMENTS

The present invention will now be described in detail below with reference to the accompanying drawings showing embodiments thereof.

Hereinafter, preferred embodiments of the present invention will be described in detail with reference to the accompanying drawings. It should be noted that the following embodiments do not limit the present invention as defined by the claims, and not all of the combinations of features described in the following embodiments are necessarily essential to the solving means of the present invention.

It should be noted that the same components are denoted by the same reference numerals and descriptions thereof will be omitted.

### <Hardware Configuration of Printing System>

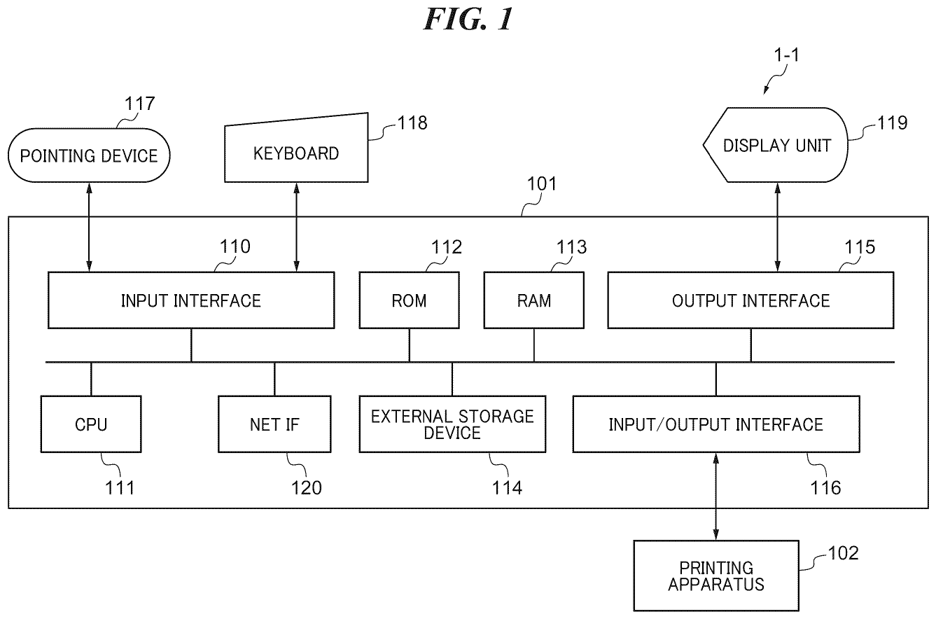

First, a first embodiment of the present invention will be described. FIG. 1 is a block diagram that shows a hardware configuration of a host computer 101 as an information processing apparatus according to the first embodiment.

As shown in FIG. 1, the host computer 101 includes an input interface 110, a central processing unit (a CPU) 111, a read only memory (a ROM) 112, a random access memory (a RAM) 113, an external storage device 114, an output interface 115, an input/output interface 116, and a NETIF 120. In addition, input devices such as a keyboard 118 and a pointing device 117 are connected to the input interface 110, and a display device such as a display unit 119 is connected to the output interface 115. In addition, a device such as a printing apparatus 102 is connected to the input/output interface 116. The NETIF 120 is a network interface, and performs control for performing data transfer with an external device (not shown) via a network (not shown).

The ROM 112 stores an initialization program. The external storage device 114 stores an application program group (a group of application programs), an operating system (an OS), print data generation software, and other various kinds of data. The RAM 113 is used as a working memory or the like when executing various kinds of programs retained in the external storage device 114, and the various kinds of programs are able to run within the host computer 101.

It should be noted that in the present embodiment, the CPU 111 performs processes according to the procedure of the program stored in the ROM 112, thereby executing the functions of the host computer 101, which will be described below, and a processing according to a flowchart, which will be described below.

In the present embodiment, the host computer 101 and the printing apparatus 102 are configured separately, but they may be configured as a single information processing apparatus. In addition, a print setting screen and a detailed setting screen, which will be described below, are displayed on the display unit 119.

It should be noted that in the present embodiment, as an example of the printing apparatus, an electrophotographic type digital multi-function peripheral having a plurality of functions such as copying, printing, and faxing will be described. However, the printing apparatus is not limited to an electrophotographic type digital multi-function peripheral, and for example, it is also possible to apply equipment using other processes such as inkjet to the present embodiment. In addition, the host computer 101 may be, for example, a desktop type personal computer, a smartphone, or a notebook type personal computer.

### <Configuration of Printing System Centered on Software>

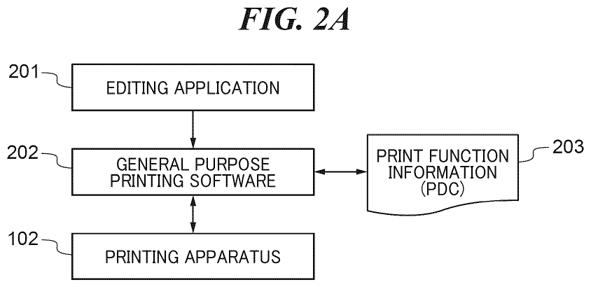

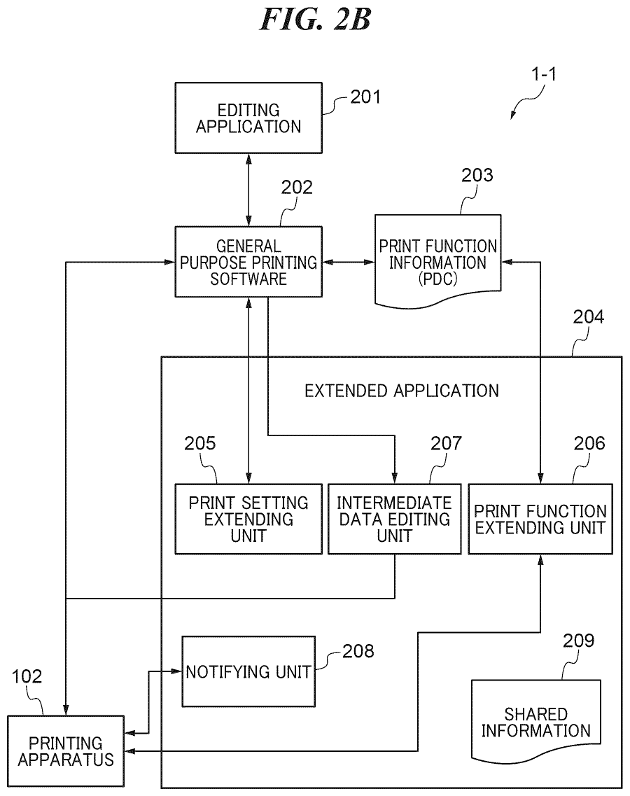

FIG. 2A is a diagram for explaining a software configuration of a conventional printing system, and FIG. 2B is a diagram for explaining a software configuration of a printing system according to the first embodiment (a printing system 1-1). Here, a case will be described in which the printing system 1-1 includes the host computer 101, into which Windows (registered trademark) 11 by Microsoft (registered trademark) has been installed as the OS.

First, the software configuration of the conventional printing system, in which an extended application 204 has not been associated with general purpose printing software 202 and the printing apparatus 102, will be described with reference to FIG. 2A.

FIG. 2A is the diagram that shows the software configuration of the conventional printing system, in which the extended application 204, which will be described below with reference to FIG. 2B, has not been associated with the general purpose printing software 202 and the printing apparatus 102.

As shown in FIG. 2A, the conventional printing system includes an editing application 201, the general purpose printing software 202, PDC 203, and the printing apparatus 102.

The editing application 201 and the general purpose printing software 202 are stored in the external storage device 114 shown in FIG. 1. Furthermore, the CPU 111 reads out the editing application 201 and the general purpose printing software 202 from the external storage device 114 into the RAM 113 and executes them to perform the following processing.

The editing application 201 is software that creates contents (rendering data) to be printed. For example, examples of the editing application 201 include a document creation application, a spreadsheet application, a presentation application, etc. When the editing application 201 receives a printing request from a user, it issues a printing instruction to the OS. The printing instruction includes print setting information for instructing the operations of the general purpose printing software 202 and the printing apparatus 102. Hereinafter, the print setting information will be referred to as a print ticket (hereinafter, also referred to as “a PT”).

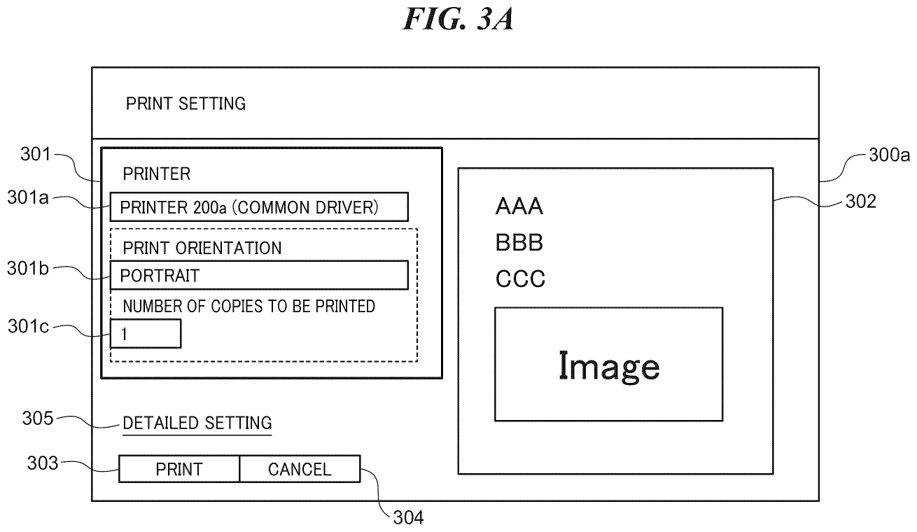

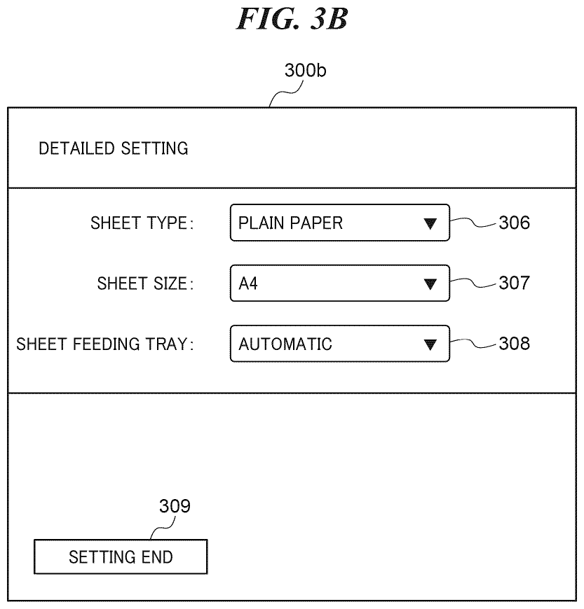

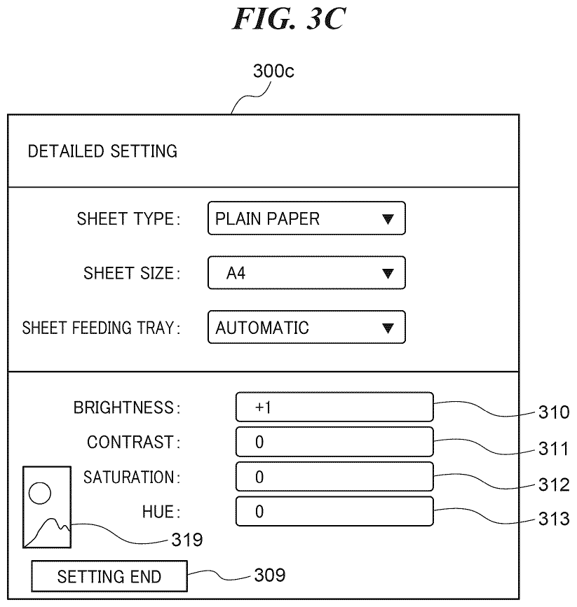

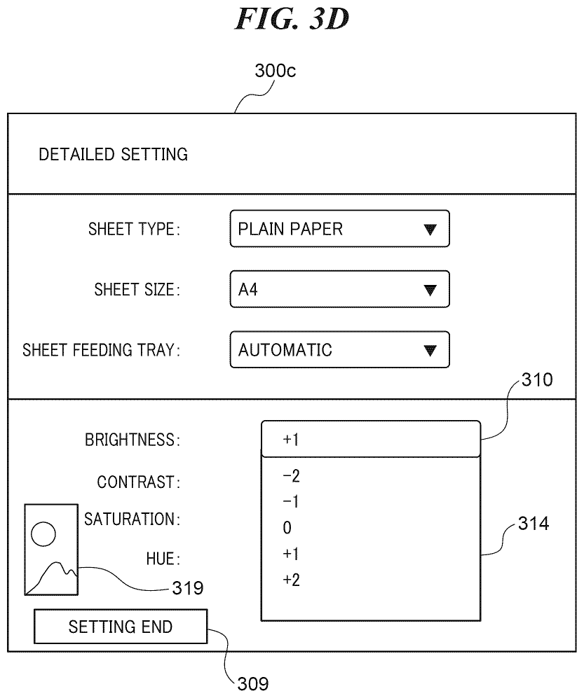

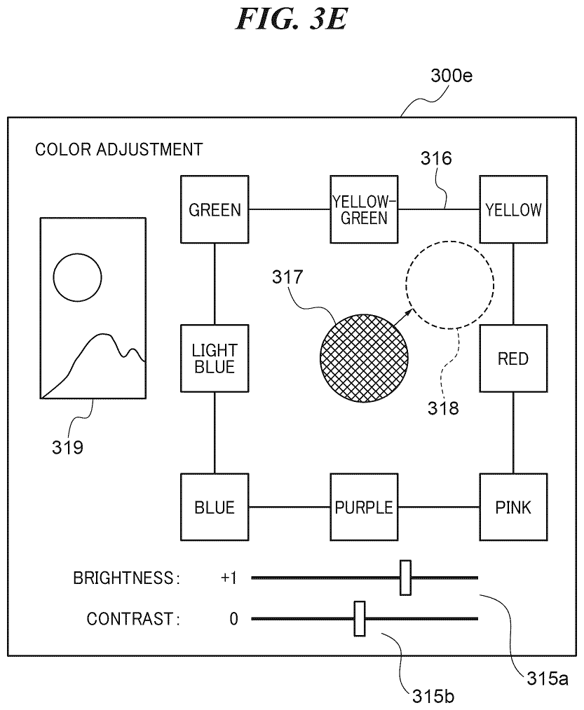

In order to generate the PT to be included in the printing instruction, the editing application 201 causes the general purpose printing software 202, the OS, or the editing application 201 (hereinafter, simply referred to as “the general purpose printing software 202”) to display a print setting screen (see FIG. 3A). In addition, when a control 305 within the print setting screen is pressed, the general purpose printing software 202 additionally displays a detailed setting screen (see FIG. 3B). The screen configurations of the print setting screen and the detailed setting screen will be described below with reference to FIGS. 3A, 3B, 3C, 3D, and 3E. The detailed setting screen includes setting items (hereinafter, also referred to as “controls”) indicating print functions that can be set according to capability information (settable information) of the general purpose printing software 202, and their setting values. The capability information is also referred to as “print capabilities” (hereinafter, sometimes referred to as “PC”).

The general purpose printing software 202 is a standard driver, and determines the PC based on the PDC (print device capabilities) 203. Here, the PDC 203 is print function information indicating print functions of the printing apparatus 102 in which all print functions that can be set by the general purpose printing software 202, their setting values, and exclusive relationships between the setting values have been described. The PDC 203 may be included in the configuration file of the general purpose printing software 202 and placed in the external storage device 114 as an unchangeable file. Alternatively, the PDC 203 may be dynamically generated by the general purpose printing software 202. Specifically, the general purpose printing software 202 or the OS may be configured to obtain attribute data of the printing apparatus 102 from the printing apparatus 102 and generate the PDC 203 according to attribute information within the obtained attribute data. It should be noted that in the case that the PDC 203 is dynamically generated, the generated PDC 203 is editable. In addition, the attribute data obtained from the printing apparatus 102 is a response obtained by issuing an IPP (Internet print protocol) “Get-Printer-Attributes” operation to the printing apparatus 102. The response includes attribute information indicating functions that can be designated in the printing apparatus 102 (the capabilities of the printing apparatus 102), and setting values related to the attribute information. In addition, the response is stored in the RAM 113.

By configuring in this way, the general purpose printing software 202 is able to be configured to, depending on the printing apparatus connected to the host computer 101 (here, the printing apparatus 102), allow the user to designate print functions that can be used in the printing apparatus connected to the host computer 101. In other words, even in the case that a printing apparatus with different functions or a printing apparatus developed by a different manufacturer is connected to the host computer 101, the general purpose printing software 202 is able to be configured to, depending on the connected printing apparatus, allow the user to designate available print functions. It should be noted that here, as the general purpose printing software 202, a configuration using “IPP Class Driver” installed in Windows (registered trademark) 11, which is the OS, will be described. The IPP Class Driver is a printer driver that executes a printing processing according to the specifications of a standard printing protocol called the IPP (Internet print protocol), and is bundled with the package of the OS. The IPP Class Driver is not a unique printer driver depending on the model of the printing apparatus 102, but a standard class driver that can be used in common by a plurality of printing apparatuses. In addition, the IPP Class Driver obtains capability information of the printing apparatus 102 from the printing apparatus 102 and generates the PDC 203 based on the obtained capability information so that the user is able to designate the print functions supported by the printing apparatus 102 connected to the host computer 101. However, the IPP Class Driver does not support color adjustment functions. This is because the color adjustment functions are functions unique to the manufacturer that provides the printing apparatus 102 (a first printing apparatus).

Here, the color adjustment functions, which are the functions unique to the manufacturer that provides the printing apparatus 102, and use cases thereof will be described. First, the color adjustment functions will be described.

### <Color Adjustment Functions>

The color adjustment functions are functions capable of adjusting the color by adjusting the brightness, the saturation (vividness), the color tone, the contrast, etc. of print data, and include at least four functions: a brightness adjustment function, a saturation adjustment function, a hue adjustment function, and a contrast adjustment function.

The brightness adjustment function is a function for adjusting the brightness of the print data, and is able to make the print data brighter or darker.

The saturation adjustment function is a function for adjusting the vividness, and is able to make the print data more vivid, or to reduce the vividness to create a more subdued impression.

The hue adjustment function is a function for adjusting the color tone, and is able to change the color tone, for example, from blue to light blue, or from yellow-green to green.

The contrast adjustment function is a function for adjusting the contrast, and by increasing the contrast, it is possible to create a sharper impression, or conversely, by decreasing the contrast, it is possible to create a natural and softer impression.

It is possible to adjust these functions (the brightness adjustment function, the saturation adjustment function, the hue adjustment function, and the contrast adjustment function) individually or in combination.

In addition, the color adjustment functions may include a function for adjusting the white balance of the print data and a function for adjusting the density of the print data.

### <Processing Example of Color Adjustment Functions>

As a processing example of the color adjustment functions, the brightness adjustment function, the contrast adjustment function, the saturation adjustment function, and the hue adjustment function of the present invention will be described. For the purposes of explanation, the color of the inputted print data is assumed to be RGB data consisting of the commonly used three RGB channels, and to take an 8-bit value from 0 to 255, but is not limited to this.

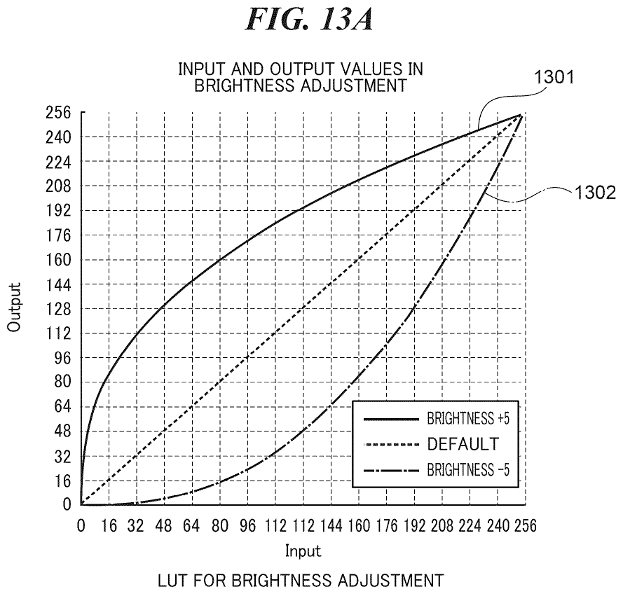

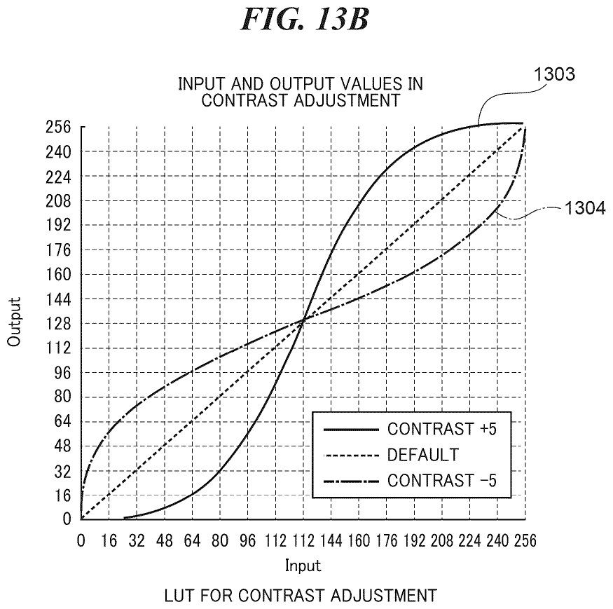

First, the brightness adjustment function will be described. In the brightness adjustment function, tone curve correction is performed for each of the RGB channels. A tone curve is a function that links an input signal value and an output signal value, and this link is performed for values from 0 to 255, for example, when the input signal value is 10, the output signal value will be 20. In the present embodiment, for example, tone curves shown in FIG. 13A (an LUT for brightness adjustment) are used. FIG. 13A is a graph that shows the tone curves in brightness adjustment, with the horizontal axis representing the input signal value and the vertical axis representing the output signal value. Although the brightness adjustment setting values will be described below, for example, among the brightness adjustment setting values, a tone curve 1301 indicates the adjustment setting values for adjusting the brightness to be brighter, and a tone curve 1302 indicates the adjustment setting values for adjusting the brightness to be darker.

In the tone curve 1301, the signal values have been linked so that the output signal value is larger than the input signal value. Conversely, in the tone curve 1302, the signal values have been linked so that the output signal value is smaller than the input signal value. Since the larger the RGB signal value, the brighter it is, and the smaller the RGB signal value, the darker it is, when the brightness adjustment is performed with the tone curve 1301, the print data becomes brighter, and when the brightness adjustment is performed with the tone curve 1302, the print data becomes darker.

Next, the contrast adjustment function will be described. Similar to the brightness adjustment function, in the contrast adjustment function, tone curve correction is performed for each of the RGB channels. In the present embodiment, for example, tone curves shown in FIG. 13B (an LUT for contrast adjustment) are used. FIG. 13B is a graph that shows the tone curves in contrast adjustment, with the horizontal axis representing the input signal value and the vertical axis representing the output signal value. Although the contrast adjustment setting values will be described below, for example, among the contrast adjustment setting values, a tone curve 1303 indicates the adjustment setting values to enhance the contrast, and a tone curve 1304 indicates the adjustment setting values to weaken the contrast.

In the tone curve 1303, in a low signal range of 0 to 127, the output signal value is smaller than the input signal value, and in a high signal range of 128 to 255, the output signal value is larger than the input signal value. As a result, since the difference in the signal value between the low signal range and the high signal range becomes larger, the difference in color visually becomes larger, resulting in a clearer impression. Conversely, in the tone curve 1304, since the difference in the signal value between the low signal range and the high signal range becomes smaller, the difference in color visually becomes smaller, resulting in a natural and softer impression.

Next, the hue adjustment function and the saturation adjustment function will be described. Since the hue adjustment and the saturation adjustment are calculated (adjusted) simultaneously, they will be collectively referred to as the hue and saturation adjustment function below. Although the hue and saturation adjustment setting values will be described below, the user designates the adjusted color tone such as yellow or red for the hue, and designates increasing/decreasing the vividness for the saturation.

In the hue and saturation adjustment function, first, a transformation matrix is obtained based on the hue and saturation adjustment setting values designated by the user. In the present embodiment, the following 3 x 6 matrix that is predetermined in association with the hue and saturation adjustment setting values is obtained.

$$[ \begin{matrix}a 11 & a 12 & a 13 & a 14 & a 15 & a 16 \\ a 21 & a 22 & a 23 & a 24 & a 25 & a 26 \\ a 31 & a 32 & a 33 & a 34 & a 35 & a 36\end{matrix} ] \qquad [ Expression 1 ]$$

Next, by using the following Expression 2, the inputted RGB signal values are decomposed into six colors, c, m, y, r, g, and b.

$$Krgb = min ( R , G , B ) \\ [ \begin{matrix}c \\ m \\ y\end{matrix} ] = [ \begin{matrix}min ( G - Krgb , B - Krgb ) \\ min ( B - Krgb , R - Krgb ) \\ min ( R - Krgb , G - Krgb )\end{matrix} ] \\ [ \begin{matrix}r \\ g \\ b\end{matrix} ] = [ \begin{matrix}R - Krgb - max ( m , y ) \\ G - Krgb - max ( y , c ) \\ B - Krgb - max ( c , m )\end{matrix} ] \qquad [ Expression 2 ]$$

By using the determined c, m, y, r, g, and b values and the obtained matrix, a correction amount ΔR for R, a correction amount ΔG for G, and a correction amount ΔB for B are calculated based on the following Expression 3.

$$[ \begin{matrix}Δ R \\ Δ G \\ Δ B\end{matrix} ] = [ \begin{matrix}a 11 & a 12 & a 13 & a 14 & a 15 & a 16 \\ a 21 & a 22 & a 23 & a 24 & a 25 & a 26 \\ a 31 & a 32 & a 33 & a 34 & a 35 & a 36\end{matrix} ] * [ \begin{matrix}r \\ g \\ b \\ y \\ c \\ m\end{matrix} ] \qquad [ Expression 3 ]$$

Finally, by using the following Expression 4, the correction amount ΔR, the correction amount ΔG, and the correction amount ΔB are added to the inputted RGB values to calculate RGB values after the hue and saturation adjustment (R′, G′, and B′).

$$[ \begin{matrix}{R}^{′} \\ {G}^{′} \\ {B}^{′}\end{matrix} ] = [ \begin{matrix}R \\ G \\ B\end{matrix} ] + [ \begin{matrix}Δ R \\ Δ G \\ Δ B\end{matrix} ] \qquad [ Expression 4 ]$$

In the present embodiment, the brightness adjustment function, the contrast adjustment function, and the hue and saturation adjustment function are implemented as described above, but are not limited to this, and any method may be used as long as it is able to adjust the brightness, the contrast, the hue, and the saturation, respectively.

### <Use Cases of Color Adjustment Functions>

Next, the use cases of the color adjustment functions will be described. In printing, various kinds of image processing including color conversion are performed with respect to the print data so as to improve the appearance of the printed matter. However, preferences for color appearance vary from person to person. In particular, preferred colors change depending on the person and the situation when it comes to photographic images, images including graphics, office document images such as presentation materials that include objects such as photographs and graphs, etc. Therefore, the color adjustment functions need to include not only the color conversion and the image processing that become the base, but also the function that allows users to adjust the color according to their preferences.

Returning to the description of FIG. 2A. When a printing instruction is issued from the editing application 201, the module of the OS within the general purpose printing software 202 generates intermediate data (also referred to as “input data”). It should be noted that the data that the editing application 201 outputs for printing is data in a graphic device interface format (data in a GDI format), or data in an XML paper specification format (data in an XPS format). In the case that the general purpose printing software 202 is the IPP Class Driver, if the data that the editing application 201 outputs is data in the GDI format, the OS converts the data in the GDI format, which is outputted from the editing application 201, into data in the XPS format. It should be noted that the intermediate data includes the rendering data, which is information on the picture to be formed on a printing sheet, and the PT set by the user.

The general purpose printing software 202 converts the obtained intermediate data into print data that can be interpreted by the printing apparatus 102, and transmits the print data to the printing apparatus 102. Here, the print data in the present embodiment refers to page description language data (PDL data) conforming to the IPP. The PDL data conforming to the IPP is, for example, data in portable document format or data in PWG-Raster format. It should be noted that the print data includes the rendering data, which is the information on the picture to be formed on the printing sheet, and print setting attribute information generated based on the PT set by the user (attribute information that designates the print setting). The print setting attribute information includes the attribute information indicating the functions that can be designated in the printing apparatus 102 (the capabilities of the printing apparatus), and the setting values related to the attribute information. However, as described above, in the case of the configuration of FIG. 2A, setting values for the functions unique to the manufacturer that provides the printing apparatus 102, such as the color adjustment functions, are not included.

The printing apparatus 102 performs printing on the printing sheet based on the print data transmitted from the general purpose printing software 202. At this time, the printing apparatus 102 forms the rendering data included in the print data on the printing sheet by performing an operation according to the print setting attribute information included in the print data. The print setting attribute information includes attribute information for designating print quality (such as image quality priority or speed priority), double-sided printing, etc., and setting values of the attribute information. For example, in the case that the print setting attribute information includes attribute information designating double-sided printing and a setting value indicating that double-sided printing should be performed, the printing apparatus 102 executes double-sided printing.

### <Configuration of Printing System Centered on Software in the First Embodiment (Case Where the Extended Application 204 Has Been Associated)>

Next, the configuration of the printing system 1-1, in which the extended application 204 has been associated, will be described with reference to FIG. 2B. It should be noted that configurations and processes not specifically mentioned below are the same as those in FIG. 2A.

FIG. 2B is the diagram that shows the software configuration of the printing system 1-1, in which the extended application 204 has been associated with the general purpose printing software 202 and the printing apparatus 102.

As shown in FIG. 2B, the printing system 1-1, like that in FIG. 2A, includes the editing application 201, the PDC 203, and the printing apparatus 102, as well as the general purpose printing software 202.

The editing application 201, the general purpose printing software 202, and the extended application 204 are stored in the external storage device 114 shown in FIG. 1. Furthermore, the CPU 111 reads out the editing application 201, the general purpose printing software 202, and the extended application 204 from the external storage device 114 into the RAM 113 and executes them to perform processes shown in a flowchart and a sequence diagram that will be described below.

The extended application 204 is software for extending the functions of the general purpose printing software 202, and is software that is not included in the OS in advance (is not bundled with the OS). Therefore, the extended application 204 needs to be downloaded from a server via the Internet and installed. This installation method may be a manual method based on a user operation with respect to the host computer 101, or an automatic method based on the connection of the printing apparatus 102 to the host computer 101. In the case of the automatic method, specifically, the extended application 204 is installed in the following manner. First, when the printing apparatus 102 is connected to the host computer 101, the OS obtains device identification information from the printing apparatus 102. The OS downloads the extended application 204 corresponding to the obtained device identification information from the server via the Internet and then install it.

It should be noted that the general purpose printing software 202 and the extended application 204 are retained in the host computer 101 as separate files. In addition, the general purpose printing software 202 and the extended application 204 may be updated and upgraded, but an update processing of the general purpose printing software 202 and an update processing of the extended application 204 are also performed at different timings. In other words, the timing at which the host computer 101 obtains the general purpose printing software 202 and the timing at which the host computer 101 obtains the extended application 204 are different. In addition, a trigger for the host computer 101 to obtain the general purpose printing software 202 and a trigger for the host computer 101 to obtain the extended application 204 are also different. It should be noted that, in the case that the extended application 204 has been installed, the OS associates the extended application 204 with the general purpose printing software 202 and the printing apparatus 102.

As shown in FIG. 2B, the extended application 204 includes a print setting extending unit 205, a print function extending unit 206, an intermediate data editing unit 207, and a notifying unit 208 (hereinafter, also referred to as units 205 to 208). In addition, the extended application 204 includes shared information 209 that can be commonly accessed from each of the units 205 to 208. Actually, the shared information 209 is a file stored in the external storage device 114 or information stored in the RAM 113. The extended application 204 uses an application program interface (an API) provided by the OS to write and read information into and from the shared information 209.

It should be noted that the extended application 204 may end its operation each time the processing of each of the units 205 to 208 ends. In this case, the OS will activate the extended application 204 every time it receives a request to use one of the units 205 to 208.

Furthermore, the extended application 204 may cancel the processing of each of the units 205 to 208 during the processing of each of the units 205 to 208. In the case of cancelling the processing of each of the units 205 to 208, a job being processed on a print queue is deleted by the OS.

When the editing application 201 receives a printing request from the user, it issues a printing instruction to the OS. In the present embodiment, similar to the configuration of FIG. 2A, the editing application 201 causes to display a print setting screen, but in the present embodiment, the extended application 204 further causes the print setting extending unit 205 to display a detailed setting screen for performing detailed settings of printing. In addition, the print setting extending unit 205 is able to store the detailed settings set by the user in the shared information 209. The print setting extending unit 205 will be described in detail below with reference to FIGS. 3A, 3B, 3C, 3D, 3E, 4, and 8.

The intermediate data editing unit 207 obtains the intermediate data from the general purpose printing software 202, edits it, converts it into print data, and then passes the print data to the printing apparatus 102. Furthermore, the intermediate data editing unit 207 obtains information on the detailed settings from the shared information 209 and adds the detailed settings to the print data. The printing apparatus 102 performs printing on a printing sheet based on the received print data. It should be noted that the method of converting the intermediate data into the print data is not limited to the method described above. The extended application 204 may be configured to obtain the print data generated by the general purpose printing software 202 and add the detailed settings to the print data. In addition, also in the configuration of the printing system 1-1 shown in FIG. 2B, there is a case where a color adjustment setting is not performed by the user. In this case, similar to the configuration of the conventional printing system shown in FIG. 2A, the general purpose printing software 202 may pass the print data to the printing apparatus 102 without going through the extended application 204.

The print function extending unit 206 is able to edit the PDC 203 generated by the general purpose printing software 202 or the OS. As a result, the print function extending unit 206 is able to perform the addition of functions provided by the extended application 204. Specifically, it is possible to perform the addition of functions that are supported by the printing apparatus 102 but not supported by the general purpose printing software 202 (for example, the color adjustment functions), the addition of the exclusive relationships between the setting values of the print functions, and the like. The OS activates the print function extending unit 206 when the extended application 204 has been first associated with the printing apparatus 102 and the general purpose printing software 202. Furthermore, the OS may activate the print function extending unit 206 at other timings, for example, when the OS is activated. By doing this, in the case that an optional device (for example, a finisher or the like) is added to the printing apparatus 102 later and a printing-related function is extended, the print function extending unit 206 is able to detect the extended printing-related function and add it to the PDC 203.

The notifying unit 208 is able to display a notification to the user in response to an error occurring in the printing apparatus 102. For example, when a sheet out error occurs in the printing apparatus 102, the general purpose printing software 202 detects the occurrence of this sheet out error, and by using a notifying function called a toast notification, which is the function of the OS, the OS causes the display unit 119 to display a message. When the user presses this toast notification, the notifying unit 208 of the extended application 204 is invoked by the OS, and a user interface screen (a UI screen) of the notifying unit 208 is displayed. On the UI screen of the notifying unit 208, for example, it is possible to display a detailed message regarding the sheet out error, a sheet filling method, etc.

It should be noted that once the extended application 204 has transmitted the print data to the printing apparatus 102, it is not possible to display on a screen, such as a guide linked to the print data, during the processing of each of the units 205 to 208.

In addition, the configuration of the extended application 204 for realizing the present embodiment is not limited to including all of the functions of the units 205 to 208 described above, but may include only some of the functions of the units 205 to 208 described above, or may include other functions. In addition, the extended application 204 may also simply be referred to as printing software. As described above, the extended application 204 includes at least one of the function for displaying the detailed setting screen, the function for adding the detailed settings to the print data, the function for extending the functions of the general purpose printing software 202, and the function for displaying the screen in response to the error occurring in the printing apparatus 102.

### <Examples of Print Setting Screen and Detailed Setting Screen>

Next, examples of the print setting screen and the detailed setting screen in the present embodiment will be described with reference to FIGS. 3A, 3B, 3C, 3D, and 3E.

FIG. 3A shows a print setting screen 300a displayed by the editing application 201. FIG. 3B shows a detailed setting screen 300b that is displayed in the case of the conventional printing system shown in FIG. 2A that does not include the extended application 204. FIG. 3C shows a detailed setting screen 300c that is displayed in the case of the printing system 1-1 shown in FIG. 2B that includes the extended application 204. It should be noted that the functions of the unit or the module that displays the print setting screen 300a are not limited to those described above. For example, the functions of the print setting extending unit 205 may be only the function of generating a display screen. In this case, the print setting extending unit 205 may transmit the generated display screen to the editing application 201 via the general purpose printing software 202, and the editing application 201 may display the obtained display screen.

### <FIG. 3A: Print Setting Screen Displayed By the Editing Application 201>

First, the print setting screen 300a shown in FIG. 3A will be described.

As shown in FIG. 3A, the print setting screen 300a includes controls 301 to 304.

The control 301 includes a printer selection pull-down menu 301a, a print orientation selection pull-down menu 301b, and a number-of-copies-to-be-printed setting section 301c.

The printer selection pull-down menu 301a displays a list of printers that can be used for printing when clicked (pressed) by the user, and allows the user to select one of the printers to set the printer to be used for printing.

The print orientation selection pull-down menu 301b displays a list of print orientations that can be set when clicked by the user, and allows the user to select one of the print orientations to set the print orientation.

The number-of-copies-to-be-printed setting section 301c displays the default number of copies to be printed (1 copy), and the number of copies to be printed is changed to +1 by clicking once on the up arrow at the top right, or −1 by clicking once on the down arrow at the bottom right.

The control 302 is a preview screen, the control 303 is a button that the user clicks to start printing, and the control 304 is a button that the user clicks to cancel printing. The control 305 is a button that, when clicked by the user, displays a detailed setting screen, enabling the user to perform detailed settings of printing.

When the control 305 is clicked by the user, in the case of the conventional printing system, the general purpose printing software 202 displays the detailed setting screen 300b (see FIG. 3B). On the other hand, in the case of the printing system 1-1, the print setting extending unit 205 displays the detailed setting screen 300c (see FIG. 3C).

### <FIG. 3B: Detailed Setting Screen Displayed by the General Purpose Printing Software 202>

Next, the detailed setting screen 300b shown in FIG. 3B will be described. The detailed setting screen 300b is an additional setting screen displayed by the general purpose printing software 202 in the conventional printing system that does not include the extended application 204.

As shown in FIG. 3B, the detailed setting screen 300b includes controls 306 to 308.

The control 306 is a sheet type selection pull-down menu, which displays a list of sheet types that can be set when clicked by the user, and allows the user to select one of the sheet types to set the type of the sheet to be used for printing. Here, the sheet type set by the control 306 is plain paper.

The control 307 is a sheet size selection pull-down menu, which displays a list of sheet sizes that can be set when clicked by the user, and allows the user to select one of the sheet sizes to set the size of the sheet to be used for printing. Here, the sheet size set by the control 307 is A4.

The control 308 is a sheet feeding tray designating pull-down menu, which, when clicked by the user, displays a list of sheet feeding trays from which sheets for printing can be fed, and allows the user to select one of the sheet feeding trays to designate the sheet feeding tray of sheets for printing. Here, the sheet feeding tray designated by the control 308 is automatic.

A control 309 is a button that the user clicks to determine settings on the detailed setting screen 300b and perform setting end, and when the control 309 is clicked by the user, returning to the print setting screen 300a shown in FIG. 3A.

### <FIGS. 3C to 3E: Print Setting Screens Displayed By the Print Setting Extending Unit 205>

Next, the detailed setting screen 300c shown in FIG. 3C will be described.

The detailed setting screen 300c shown in FIG. 3C is an additional setting screen displayed by the print setting extending unit 205 (an adding unit) in the printing system 1-1 that includes the extended application 204. In addition to including the controls 306 to 308 similar to those of the detailed setting screen 300b shown in FIG. 3B, the detailed setting screen 300c includes controls 310 to 313 that allow the user to select setting values for color adjustment, and a control 319 that displays an image (an impression) of the adjusted color.

The control 310 is a brightness adjustment pull-down menu, which displays a list of adjustable brightnesses when clicked by the user, and allows the user to select one of the adjustable brightnesses to adjust the brightness when printing. Here, the brightness adjusted by the control 310 is +1, which is one stage brighter than the default 0.

The control 311 is a contrast adjustment pull-down menu, which displays a list of adjustable contrasts when clicked by the user, and allows the user to select one of the adjustable contrasts to adjust the contrast when printing. Here, the contrast adjusted by the control 311 is the default 0.

The control 312 is a saturation adjustment pull-down menu, which displays a list of adjustable saturations when clicked by the user, and allows the user to select one of the adjustable saturations to adjust the saturation when printing. Here, the saturation adjusted by the control 312 is the default 0.

The control 313 is a hue adjustment pull-down menu, which displays a list of adjustable hues when clicked by the user, and allows the user to select one of the adjustable hues to adjust the hue when printing. Here, the hue adjusted by the control 313 is the default 0.

The control 319 is a screen that displays the image (the impression) of the adjusted color. Details will be described below with reference to FIG. 3E.

FIG. 3D shows, as an example, a case where the control 310 on the detailed setting screen 300c is pressed and a list 314, which displays the list of the adjustable brightnesses (setting values), is displayed. The list 314 shows that in addition to the currently selected “+1”, there are “−2”, “−1”, “0”, and “+2”. The brightness adjustment setting “0” indicates that the brightness adjustment processing is not performed, that is, indicates the default. The brightness adjustment settings “+1” and “+2” are settings for adjusting the print data to be brighter, with “+2” being brighter than “+1”. The brightness adjustment settings “−1” and “−2” are settings for adjusting the print data to be darker, with “−2” being darker than “−1”. By selecting a setting value that provides a desired brightness from the list 314, the user is able to switch the brightness and perform printing.

Furthermore, instead of a UI that perform the color adjustment by allowing the user to select the setting value as shown in the list 314 shown in FIG. 3D, a UI that perform the color adjustment visually, for example, by using slide bars 315a and 315b, and a pointer 317 that are shown in FIG. 3E may be used. That is, an area surrounded by a dotted line on the detailed setting screen 300c may be replaced with a setting image 300e (see FIG. 3E). In FIG. 3E, the slide bar 315a sets the brightness adjustment to “+1”, and the slide bar 315b sets the contrast to “0”. In addition, in FIG. 3E, a hue and saturation adjustment display 316 is set by moving the pointer 317 to the position of the hue and saturation that the user wants to set. For example, by moving the pointer 317 to a position 318, it is possible to set the hue to “+2” toward yellow and set the saturation to “+1”. In other words, the center of the hue and saturation adjustment display 316 is set as the origin, no hue and saturation setting is performed, the hue is set at an angle according to the position where the pointer 317 is placed, and the saturation is set according to a distance from the origin.

Furthermore, the control 319 in FIG. 3E is the screen that displays the image (the impression) of the adjusted color, and may be configured to display an image (an impression) after the color adjustment so that the results of the brightness adjustment, the contrast adjustment, the hue adjustment, and the saturation adjustment can be visually understood. In addition, here, an image (an impression) of the entire print data is displayed in the control 319, but it is also possible to select and display the object to be color-adjusted, such as a photo, a text, or graphics, or to display a separate image that makes it easy to see the results of the color adjustment.

Here, the reason why the print setting items are different between the detailed setting screen 300b shown in FIG. 3B and the detailed setting screen 300c shown in FIG. 3C and FIG. 3D will be described.

Both of the detailed setting screen 300b and the detailed setting screen 300c are generated by referring to the PC generated based on the print function information. However, since the general purpose printing software 202 does not support the brightness adjustment function, the contrast adjustment function, the saturation adjustment function, and the hue adjustment function that are the color adjustment functions, it is not possible to add the color adjustment functions to the print function information. In addition, even in the case that the print function information originally has included the color adjustment functions, since the general purpose printing software 202 is not able to interpret the color adjustment functions included in the print function information, it is not possible to display the print setting items related to the color adjustment on the detailed setting screen 300b. On the other hand, in the printing system 1-1, the print function extending unit 206 is configured to add the color adjustment functions to the PDC 203, and the print setting extending unit 205 refers to the PC to cause the detailed setting screen 300c to display the print setting items related to the color adjustment. As a result, in the printing system 1-1, the extended application 204 becomes able to cause the detailed setting screen to display the color adjustment settings.

<Flowchart of the Print Function Extending Unit 206 that Edits the PDC 203 in the First Embodiment>

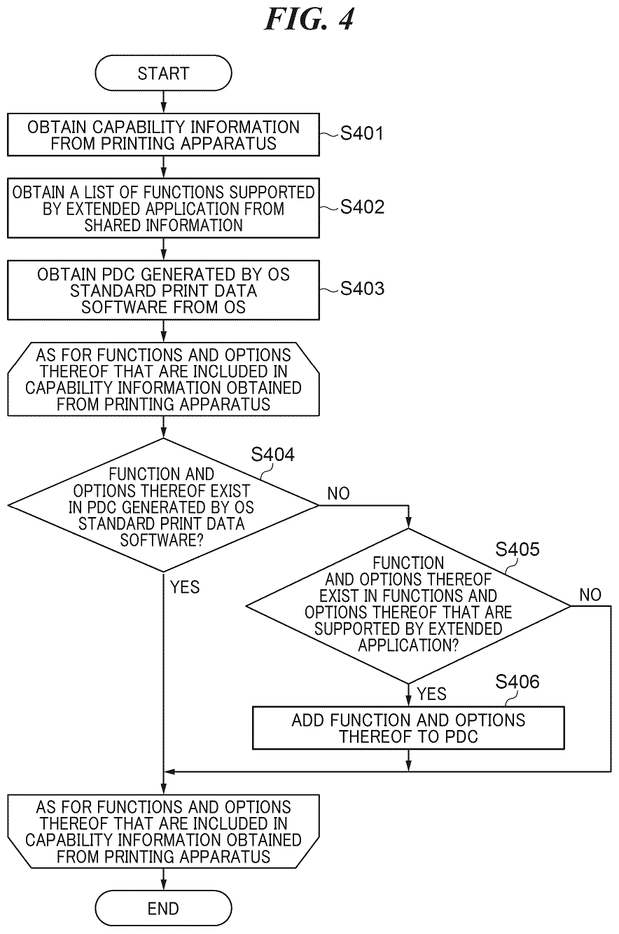

Here, a PDC editing processing according to the first embodiment executed by the print function extending unit 206 will be described with reference to a flowchart shown in FIG. 4. It should be noted that respective steps in FIG. 4 are performed by the CPU 111 controlling the print function extending unit 206. In addition, in this description, an example will be described in which the brightness adjustment is performed by using the brightness adjustment function, which is one of the color adjustment functions, but other color adjustment functions can also be performed by using similar processing.

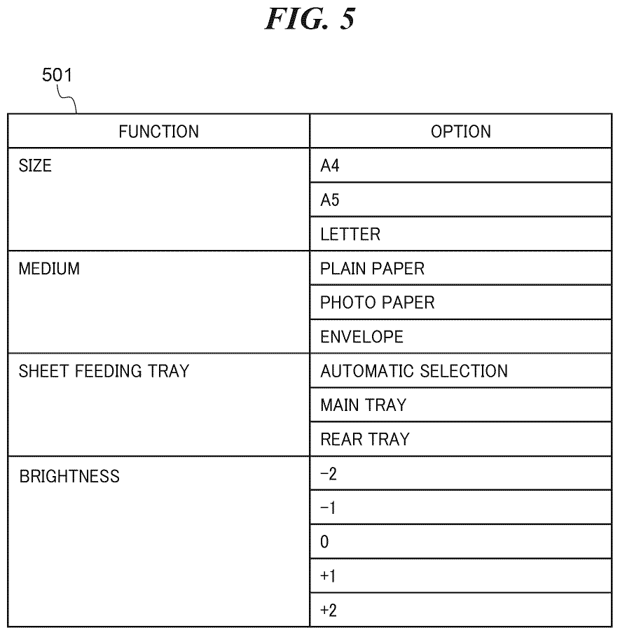

As shown in FIG. 4, first, in a step S401, the print function extending unit 206 (an obtaining unit) obtains the capability information from the printing apparatus 102. The capability information is the attribute information indicating the functions that can be designated in the printing apparatus 102 and the setting values related to the attribute information, which are included in the response obtained by issuing the IPP “Get-Printer-Attributes” operation to the printing apparatus 102. A table 501 shown in FIG. 5 is an example of a list of the capability information obtained from the printing apparatus 102. As shown in the table 501, it is possible to obtain, from the printing apparatus 102, options (setting values) that are settable with respect to respective functions such as the color adjustment function (here, the brightness adjustment function) and a sheet size selection function.

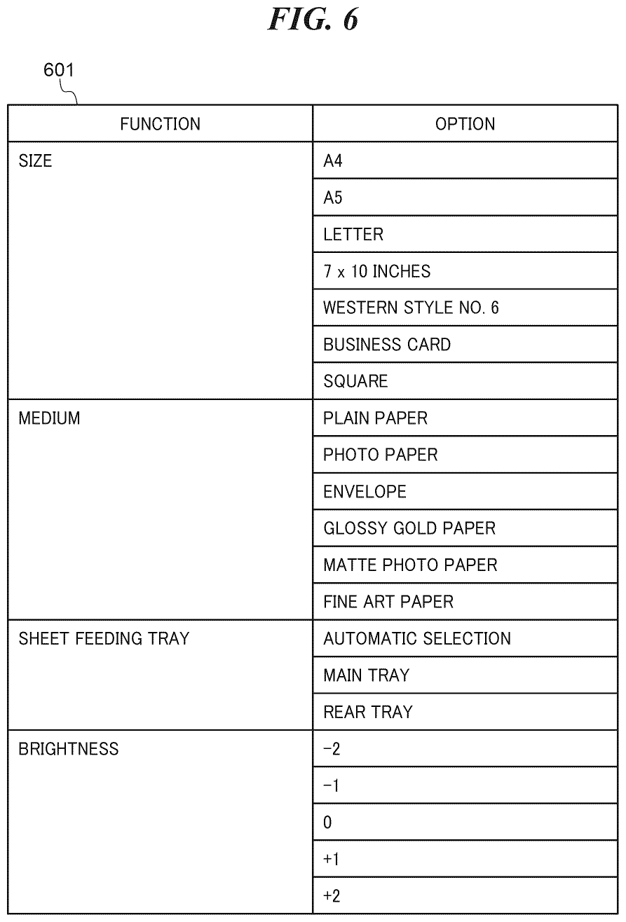

Next, in a step S402, the print function extending unit 206 obtains a list of the print functions supported by the extended application 204 from the shared information 209. The list of the print functions supported by the extended application 204 has been stored in the shared information 209, and includes all print functions that can be processed by the extended application 204 and their setting values. A table 601 shown in FIG. 6 is an example of the print functions supported by the extended application 204 and setting values thereof. It should be noted that the list of the print functions supported by the extended application 204 may be updated by, for example, updating the extended application 204.

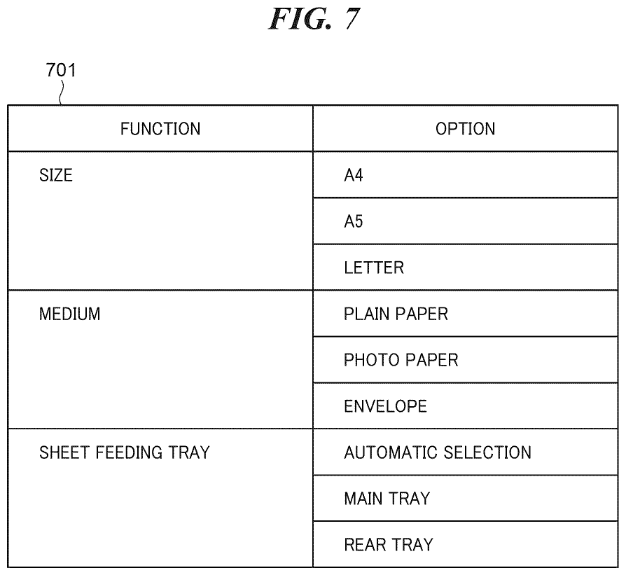

Next, in a step S403, the print function extending unit 206 obtains the PDC 203, which has been created by the general purpose printing software 202, from the OS. The PDC 203 created by the general purpose printing software 202 is created based on the table 501 indicating the capability information, which has been obtained by the general purpose printing software 202 from the printing apparatus 102. Since the PDC created by the general purpose printing software 202 describes only the print functions that the general purpose printing software 202 supports (is able to interpret) from among the capability information obtained from the printing apparatus 102, the function of the PDC is limited. A table 701 shown in FIG. 7 is an example of the print functions supported by the general purpose printing software 202 and setting values thereof. For example, the table 501 obtained from the printing apparatus 102 includes, as the sheet size, “7×10 inches” and “western style No. 6”, but the general purpose printing software 202 does not support the sheet size “7×10 inches” and the sheet size “western style No. 6”, and the PDC does not describe the sheet size “7×10 inches” and the sheet size “western style No. 6”. The color adjustment function is also not supported, and is therefore not described in the PDC. The print function extending unit 206 adds functions and options thereof to the PDC, which enables the extended application 204 to compensate for insufficient functions of the general purpose printing software 202. In addition, the print function extending unit 206 is also able to delete unnecessary functions and options thereof from the PDC created by the general purpose printing software 202.

Subsequent steps S404, S405, and S406 are processes that are repeatedly performed for the list of the functions included in the capability information obtained from the printing apparatus 102 in the step S401. In the present embodiment, the steps S404, S405, and S406 are repeatedly performed for all 16 options (size: A4 to color adjustment: +2) included in the table 501.

In the step S404, the print function extending unit 206 determines whether or not the item (the function and options thereof) currently being processed, among the capability information obtained from the printing apparatus 102 in the step S401, exists in the PDC generated by the general purpose printing software 202. In the case that the item (the function and options thereof) currently being processed exists in the PDC (YES in the step S404), the print function extending unit 206 selects the next item from among the functions and options thereof that are included in the capability information obtained from the printing apparatus 102, and returns the PDC editing processing to the step S404. It should be noted that in the case that the item currently being processed in the step S404 is the last item among the functions and options thereof that are included in the capability information obtained from the printing apparatus 102, the print function extending unit 206 ends the PDC editing processing shown in FIG. 4. On the other hand, in the case that the item (the function and options thereof) currently being processed does not exist in the PDC (NO in the step S404), the print function extending unit 206 advances the PDC editing processing to the step S405. For example, in the case that size: A4 shown in the table 501 which is the capability information of the printing apparatus 102 is the item currently being processed in the step S404, this item also exists in the table 701 which is the capability information of the general purpose printing software 202. In this case, it is determined that YES in the step S404, and for the item next to be processed (size: A5), the processing proceeds to the determining processing in the step S404. On the other hand, in the case that brightness: +1 shown in the table 501 is the item currently being processed, this item does not exist in the table 701. In this case, it is determined that NO in the step S404, and the processing proceeds to the step S405.

In the step S405, the print function extending unit 206 determines whether or not the item (the function and options thereof) currently being processed exists in the functions and options thereof that are supported by the extended application 204 obtained in the step S402. That is, the print function extending unit 206 determines whether or not the item currently being processed is the item supported by the extended application 204. In the case that the item currently being processed is the item supported by the extended application 204 (YES in the step S405), the processing proceeds to the step S406. On the other hand, in the case that the item currently being processed is not the item supported by the extended application 204 (NO in the step S405), the same process as that performed in the case of being determined that YES in the step S404 is performed. In other words, in the case that the item currently being processed is not the last item, the print function extending unit 206 selects the next item and returns the PDC editing processing to the step S404, and on the other hand, in the case that the item currently being processed is the last item, the print function extending unit 206 ends the PDC editing processing shown in FIG. 4. For example, in the case that the item currently being processed is brightness: +1, this item also exists in the table 601 which is the capability information of the extended application 204. In this case, it is determined that YES in the step S405, and the processing proceeds to the step S406.

In the step S406, the print function extending unit 206 adds the item (the function and options thereof) currently being processed to the PDC 203. After the process of the step S406, the same process as that performed in the case of being determined that YES in the step S404 is performed.

As described above, the print function extending unit 206 adds, to the PDC 203, the functions and options thereof that are not supported by the general purpose printing software 202, but supported by the printing apparatus 102 and the extended application 204. Among the PDC 203 edited by this process, as to those supported by the general purpose printing software 202, the PC is generated by the general purpose printing software 202, and as to those not supported by the general purpose printing software 202, the PC is generated by the print setting extending unit 205. Furthermore, the print setting extending unit 205 is able to generate the display screen based on the generated PC, thereby extending the functions that are not supported by the general purpose printing software 202, and displaying the detailed setting screen 300c shown in FIG. 3C and FIG. 3D.

### <Sequence After the Editing Application 201 Accepts Print Setting in the First Embodiment>

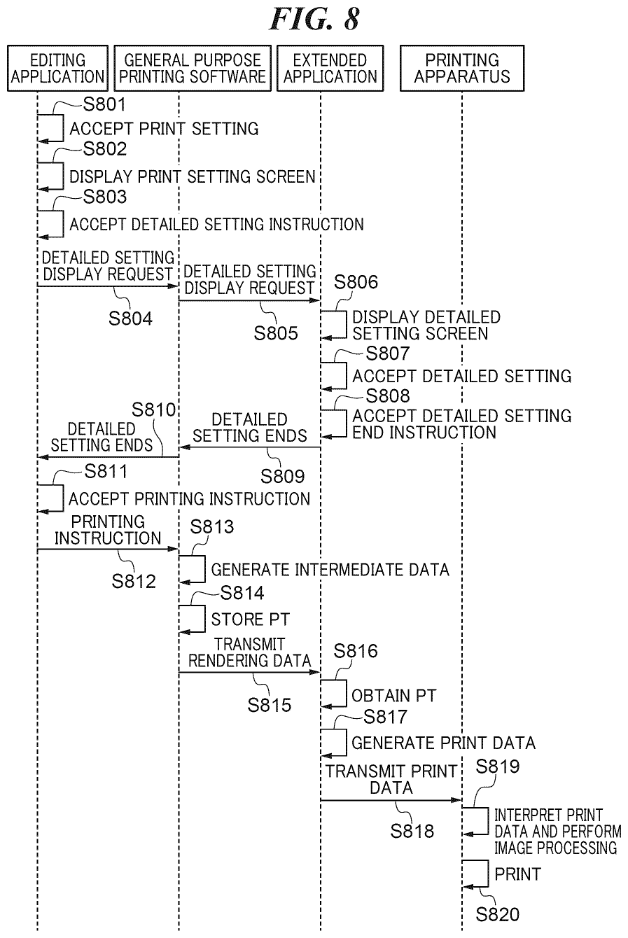

Next, a printing processing according to the first embodiment executed by the editing application 201, the general purpose printing software 202, the extended application 204, and the printing apparatus 102 after the editing application 201 accepts a print setting will be described with reference to a sequence shown in FIG. 8. It should be noted that respective steps other than respective steps for the printing apparatus 102 in FIG. 8 are performed by the CPU 111 controlling the editing application 201, the general purpose printing software 202, and the extended application 204. In addition, the respective steps for the printing apparatus 102 in FIG. 8 are performed by a CPU (not shown) within the printing apparatus 102.

As shown in FIG. 8, first, in a step S801, the editing application 201 accepts a print setting from the user. The user is able to operate the pointing device 117 or the keyboard 118 to instruct the editing application 201 to perform the print setting.

Next, in a step S802, the editing application 201 displays the print setting screen 300a shown in FIG. 3A on the display unit 119.

Next, in a step S803, the editing application 201 accepts a detailed setting instruction from the user. The user is able to issue a request to display detailed settings (a detailed setting display request) by operating the pointing device 117 or the keyboard 118 to select the control 305. Specifically, when the control 305 on the print setting screen 300a is pressed, the sequence proceeds to a step S804.

Next, in the step S804, the editing application 201 makes the detailed setting display request with respect to the general purpose printing software 202.

Next, in a step S805, the general purpose printing software 202 makes the detailed setting display request with respect to the extended application 204. It should be noted that, as described above, in the conventional printing system shown in FIG. 2A, the general purpose printing software 202 displays the detailed setting screen 300b shown in FIG. 3B.

Next, in a step S806, the print setting extending unit 205 of the extended application 204 displays the detailed setting screen 300c shown in FIG. 3C. As described with reference to FIG. 4, the brightness setting is added to the PDC by the print function extending unit 206. The print setting extending unit 205 displays the detailed setting screen 300c shown in FIG. 3C by referring to the PC generated based on the PDC after the brightness setting has been added.

Next, in a step S807, the print setting extending unit 205 accepts detailed settings. For example, as shown in the detailed setting screen 300c shown in FIG. 3C, when the user selects the sheet type: plain paper, the sheet size: A4, the sheet feeding tray: automatic, and the brightness: +1, the print setting extending unit 205 accepts these as the detailed settings.

Next, in a step S808, the print setting extending unit 205 accepts a detailed setting end instruction. Specifically, the user operates the pointing device 117 or the keyboard 118 to select the control 309 and issue the detailed setting end instruction to the print setting extending unit 205.

Next, in a step S809, the extended application 204 notifies the general purpose printing software 202 that the detailed settings have been ended.

Next, in a step S810, the general purpose printing software 202 notifies the editing application 201 that the detailed settings have been ended.

Next, in a step S814, the editing application 201 accepts a printing instruction from the user. Specifically, the user issues the printing instruction by operating the pointing device 117 or the keyboard 118 to select the control 303.

Next, in a step S812, the editing application 201 transmits the printing instruction to the general purpose printing software 202.

Next, in a step S816, the general purpose printing software 202 uses the module of the OS to generate intermediate data.

Next, in a step S814, the general purpose printing software 202 stores, in the shared information 209, the PT included in the printing instruction transmitted in the step S812.

Next, in a step S815, the general purpose printing software 202 passes the rendering data included in the intermediate data generated in the step S813, to the extended application 204.

Next, in a step S816, the intermediate data editing unit 207 of the extended application 204 obtains the PT, which has been stored in the step S814, from the shared information 209.

Next, in a step S817, the intermediate data editing unit 207 of the extended application 204 (a converting unit) uses the rendering data passed from the general purpose printing software 202 in the step S815 and the PT obtained in the step S816 to generate print data.

Next, in a step S818, the intermediate data editing unit 207 of the extended application 204 (a transmitting unit) transmits the print data generated in the step S817 to the printing apparatus 102.

Next, in a step S819, the printing apparatus 102 interprets the print data and performs a necessary image processing with respect to the image of the print data. For example, in the case that the print setting shown on the detailed setting screen 300c shown in FIG. 3C has been performed in the step S807, the brightness +1 image processing is performed. That is, brighter image data is generated compared to in the case that the brightness adjustment processing is not performed.

Next, in a step S820, the printing apparatus 102 prints the print data including the image after the image processing in the step S819, and ends the sequence shown in FIG. 8. For example, in the case that the brightness +1 image processing has been performed in the step S819, compared to in the case that the brightness adjustment processing is not performed, a brighter image will be printed.

As described above, according to the first embodiment, the print setting extending unit 205 modifies the PDC 203 based on the capability information of the general purpose printing software 202, the capability information of the extended application 204, and the capability information of the printing apparatus 102. Furthermore, when the detailed setting screen is requested by the user, the detailed setting screen 300c is displayed based on the PC generated from the PDC 203. As a result, the user is able to perform the color adjustment of the image of the print data. Furthermore, since the intermediate data editing unit 207 generates the print data based on the color adjustment set based on the detailed setting screen 300c, it is possible to reflect the color adjustment settings in the print data. Thereafter, when the printing apparatus 102 receives the print data reflecting the color adjustment settings from the intermediate data editing unit 207, a color adjustment module within the printing apparatus 102 performs a color adjustment processing with respect to the image data based on the color adjustment settings. Through a series of the processes described above, it is possible to cause the printing apparatus 102 to achieve the color adjustment functions, and hence it becomes possible to provide the user with the color adjustment functions.

It should be noted that in the first embodiment, the case that the printing system 1-1 shown in FIG. 2B provides the detailed setting screen 300c shown in FIG. 3C has been described, but the present invention is not limited to this case. For example, in the case that the detailed setting display request is made to the general purpose printing software 202 in the step S804, the general purpose printing software 202 may display the detailed setting screen 300b shown in FIG. 3B. Next, after the detailed settings on the detailed setting screen 300b shown in FIG. 3B have been ended, the general purpose printing software 202 requests the extended application 204 to display an additional detailed setting screen (the area surrounded by the dotted line in FIG. 3C), that is, transmits an additional detailed setting screen display request to the extended application 204. Next, in response to the additional detailed setting screen display request, the extended application 204 causes to additionally display the area surrounded by the dotted line in FIG. 3C so that the color adjustment settings become possible on the detailed setting screen 300b.

In addition, in the first embodiment, the extended application 204 has generated the print data based on the intermediate data generated by the general purpose printing software 202. However, the extended application 204 itself may generate the intermediate data.

Hereinafter, a second embodiment of the present invention will be described. In the first embodiment, first, the extended application 204 generates the print data including the color adjustment settings and transmits the print data to the printing apparatus 102. Next, the printing apparatus 102 interprets the print data including the color adjustment settings, and performs the color adjustment processing by means of the color adjustment module within the printing apparatus 102.

However, instead of the printing apparatus 102, a printing apparatus 901 (a second printing apparatus) that does not include a color adjustment module due to cost considerations and the like may be connected to the host computer 101. In this case, even in the case that the extended application 204 generates the print data including the color adjustment settings, the printing apparatus 901 is not able to perform the color adjustment processing based on the color adjustment settings.

Therefore, in the second embodiment, in the case that the printing apparatus 901 that does not include the color adjustment module is connected to the host computer 101, an extended application 902 generates print data including an image after the color adjustment processing and passes it to the printing apparatus 901.

Specifically, in the second embodiment, first, the extended application 902 obtains the capability information of the printing apparatus connected to the host computer 101. Next, the extended application 902 determines, based on the obtained capability information, whether the printing apparatus connected to the host computer 101 is the printing apparatus 102 including the color adjustment module, or the printing apparatus 901 not including the color adjustment module. Next, in the case of being determined that the printing apparatus connected to the host computer 101 is the printing apparatus 102 including the color adjustment module, similar to the first embodiment, the extended application 902 generates the print data reflecting the color adjustment settings and passes it to the printing apparatus 102. On the other hand, in the case of being determined that the printing apparatus connected to the host computer 101 is the printing apparatus 901 not including the color adjustment module, the extended application 902 performs the color adjustment processing with respect to the image of the rendering data. Next, the extended application 902 generates the print data including the image after the color adjustment processing and passes it to the printing apparatus 901. As a result, even in the case that the printing apparatus 901 that does not include the color adjustment module is connected to the host computer 101, it becomes possible to provide the user with the color adjustment functions.

It should be noted that in the following description, only the differences from the first embodiment will be described. The second embodiment differs from the first embodiment in that the second embodiment includes the extended application 902 that has an internal configuration different from that of the extended application 204 shown in FIG. 2B, and in that the printing apparatus 901 not including the color adjustment module is connected to the host computer 101. In addition, due to these differences, the PDC editing processing, and the printing processing after the editing application 201 accepts the print setting also differ from those in the first embodiment (see FIG. 4 and FIG. 8).

### <Configuration of Printing System Centered on Software in the Second Embodiment (Case Where the Extended Application 902 Has Been Associated)>

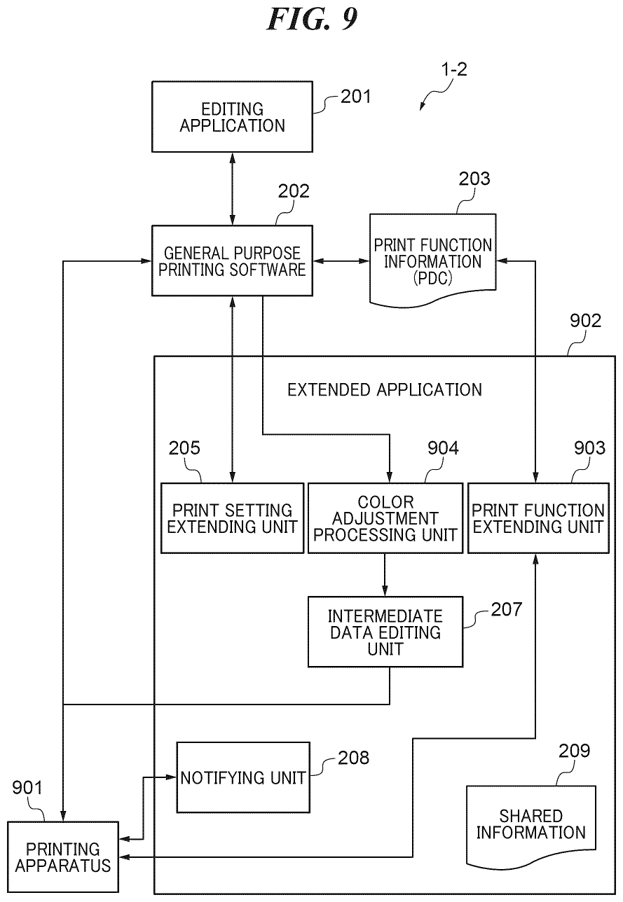

First, the configuration of a printing system according to the second embodiment (a printing system 1-2 in which the extended application 902 has been associated) will be described with reference to FIG. 9. In FIG. 9, blocks having the same reference numerals as those in FIG. 2B are the same as those in the first embodiment, and therefore description thereof will be omitted.

In FIG. 9, there are four blocks that differ from FIG. 2B: the printing apparatus 901, the extended application 902, a print function extending unit 903, and a color adjustment processing unit 904. The printing apparatus 901 in the second embodiment differs from the printing apparatus 102 in the first embodiment, and is a printing apparatus that does not include the color adjustment module. The extended application 902 has a configuration different from that of the extended application 204 of the first embodiment. Unlike the first embodiment, in the case that the capability information obtained from the printing apparatus 901 does not include the color adjustment functions, the print function extending unit 903 adds, to the PDC 203, the color adjustment functions included in the color adjustment processing unit 904 within the extended application 902. The color adjustment processing unit 904 performs the color adjustment processing with respect to the image of the intermediate data (the rendering data) received from the general purpose printing software 202 based on the color adjustment settings made by the user. Details will be described below.

<Flowchart of the Print Function Extending Unit 903 that Edits the PDC 203 in the Second Embodiment>

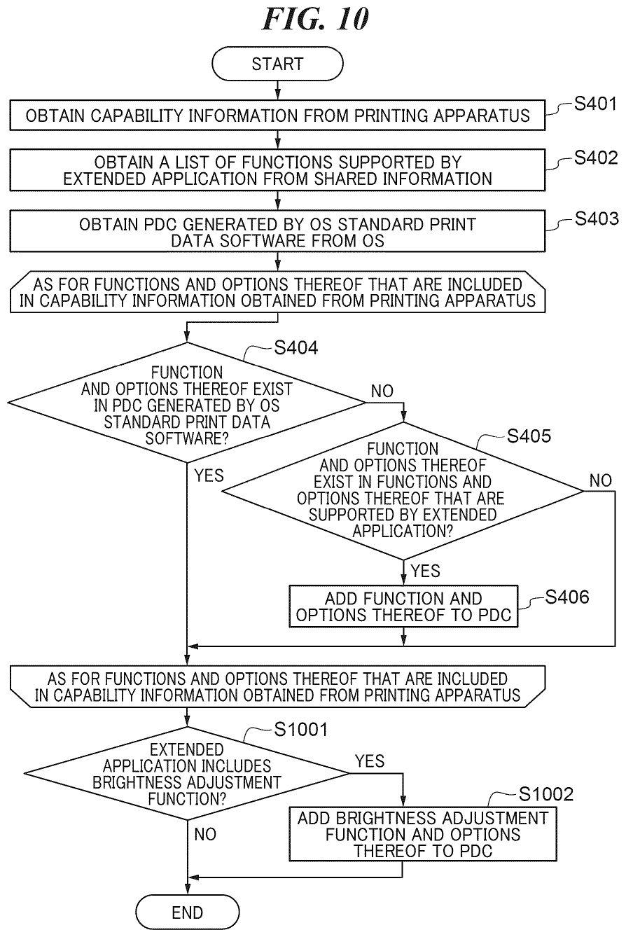

Here, a PDC editing processing according to the second embodiment executed by the print function extending unit 903 will be described with reference to a flowchart shown in FIG. 10. It should be noted that respective steps in FIG. 10 are performed by the CPU 111 controlling the print function extending unit 903. In addition, in FIG. 10, steps having the same reference numerals as those in FIG. 4 are the same processes as those in FIG. 4, and therefore the description thereof will be omitted. In addition, in this description, an example will be described in which the brightness adjustment is performed by using the brightness adjustment function, which is one of the color adjustment functions, but other color adjustment functions can also be performed by using similar processing.

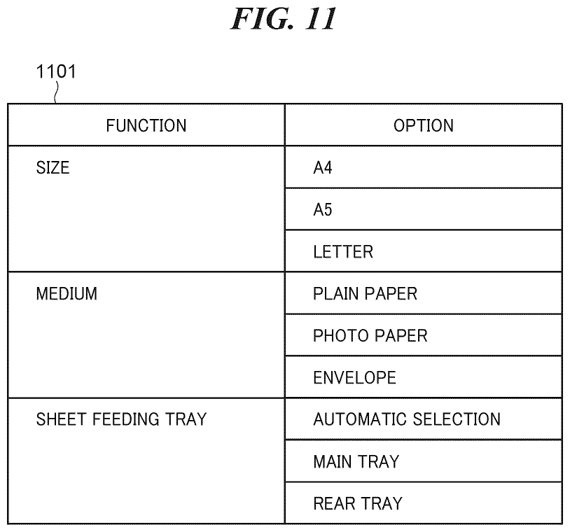

After the processes of the steps S401 to S403, the print function extending unit 903 advances the PDC editing processing to a step S1001 when the repeated processes of the steps S404 to S406 are ended. Here, unlike the printing apparatus 102, the printing apparatus 901 in the second embodiment does not include the color adjustment module, and as shown in a table 1101 shown in FIG. 11, the capability information obtained from the printing apparatus 901 in the step S401 does not include the brightness adjustment function. Therefore, the brightness adjustment function has not been added to the edited PDC 203 after the repeated processes of the steps S404 to S406 are ended.

In the step S1001, the print function extending unit 903 determines whether or not the extended application 902 includes the color adjustment functions (here, particularly, the brightness adjustment function) included in the color adjustment module included in the printing apparatus 102. In the case that the extended application 902 includes the brightness adjustment function (YES in the step S1001), the print function extending unit 903 advances the PDC editing processing to a step S1002. On the other hand, in the case that the extended application 902 does not include the brightness adjustment function (NO in the step S1001), the print function extending unit 903 ends the PDC editing processing. Since the extended application 902 in the second embodiment includes the color adjustment processing unit 904 including the brightness adjustment function, the PDC editing processing proceeds to the step S1002. It should be noted that the color adjustment processing unit 904 performs the brightness adjustment in five stages: −2, −1, 0, +1, and +2.

Next, in the step S1002, the print function extending unit 903 adds the brightness adjustment function and options thereof (the brightness adjustment: −2, −1, 0, +1, and, +2) of the color adjustment processing unit 904 to the PDC 203.

As described above, first, the print function extending unit 903 adds, to the PDC 203, the functions and options thereof that are not supported by the general purpose printing software 202, but supported by the printing apparatus 901. Thereafter, in the case that the extended application 902 includes the color adjustment processing unit 904, the capability information (the functions and options thereof) included in the color adjustment processing unit 904 is added to the PDC 203. As a result, even in the case that the printing apparatus 901 that does not include the color adjustment module is connected to the host computer 101, the print setting extending unit 205 becomes able to display the detailed setting screen shown in FIG. 3C.

### <Sequence After the Editing Application 201 Accepts Print Setting in the Second Embodiment>

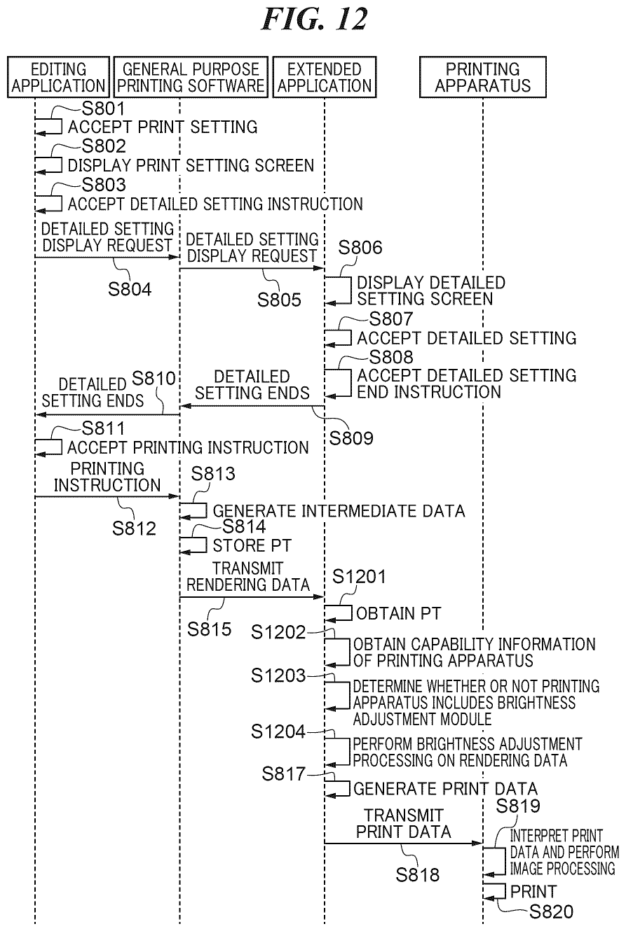

Next, a printing processing according to the second embodiment executed by the editing application 201, the general purpose printing software 202, the extended application 902, and the printing apparatus 901 after the editing application 201 accepts a print setting will be described with reference to a sequence shown in FIG. 12. It should be noted that respective steps other than respective steps for the printing apparatus 901 in FIG. 12 are performed by the CPU 111 controlling the editing application 201, the general purpose printing software 202, and the extended application 902. In addition, the respective steps for the printing apparatus 901 in FIG. 12 are performed by a CPU (not shown) within the printing apparatus 901. In addition, in FIG. 12, steps having the same reference numerals as those in FIG. 8 are the same processes as those in FIG. 8, and therefore the description thereof will be omitted. In the second embodiment, as an example, a case will be described in which the user selects the brightness adjustment: +1 as the brightness adjustment setting on the detailed setting screen and the editing application 201 accepts the print setting.

After the processes of the steps S801 to S815 are ended, in a step S1201, the color adjustment processing unit 904 of the extended application 902 obtains the PT and obtains the brightness adjustment setting. In the case that the obtained brightness adjustment setting is the brightness adjustment: 0, since the brightness adjustment processing is not performed, subsequent steps S1202 to S1204 are skipped, and the sequence proceeds to the step S817 to generate the print data. On the other hand, in the case that the obtained brightness adjustment setting is a brightness adjustment setting value other than 0, since the brightness adjustment processing is performed, the sequence proceeds to the step S1202.

Next, in the step S1202, the color adjustment processing unit 904 obtains the capability information of the printing apparatus 901 from the shared information 209. It should be noted that in the case that the capability information of the printing apparatus 901 has not been retained in the shared information 209, after the print function extending unit 903 requests the capability information from the printing apparatus 901 and stores the capability information in the shared information 209, the process of the step S1202 is executed.

Next, in the step S1203, the color adjustment processing unit 904 determines, based on the capability information obtained in the step S1202, whether or not the printing apparatus 901 includes a module related to the color adjustment (here, a brightness adjustment module) included in the print setting. The printing apparatus 901 does not include the brightness adjustment module. For this reason, in the case of the second embodiment, it is determined that the printing apparatus 901 does not include the brightness adjustment module (NO in the step S1203), and the sequence proceeds to the step S1204. On the other hand, in the case of being determined that the printing apparatus 901 includes the brightness adjustment module (YES in the step S1203), the step S1204 is skipped, and the sequence proceeds to the step S817 to generate the print data. This is because, generally, in the case that the printing apparatus includes the color adjustment module, the color adjustment module is configured with a dedicated module capable of high-speed processing, whereas the extended application 902 (the color adjustment processing unit 904) is configured with a general purpose processing module. For example, the brightness adjustment module within the printing apparatus 102 is capable of high-speed processing by using an application specific integrated circuit (an ASIC).

Next, in the step S1204, the color adjustment processing unit 904 (a color adjustment processing unit) performs the brightness adjustment processing with respect to the rendering data passed from the general purpose printing software 202 in the step S815, based on the brightness adjustment setting obtained in the step S1201. Thereafter, the color adjustment processing unit 904 stores the adjusted rendering data in the shared information 209. In addition, the brightness adjustment setting of the PT is edited to “0”. Alternatively, the brightness adjustment setting is deleted from the PT. Thereafter, the sequence proceeds to the step S817 to generate the print data.

As described above, in the first embodiment, the intermediate data editing unit 207 generates the print data reflecting the color adjustment settings and transmits the print data to the printing apparatus 102, thereby making it possible to provide the user with the color adjustment functions. On the other hand, in the second embodiment, first, the color adjustment processing unit 904 determines whether or not the printing apparatus 901 includes the color adjustment module. In the case that the printing apparatus 901 does not include the color adjustment module, the color adjustment processing unit 904 performs the color adjustment processing with respect to the rendering data. On the other hand, in the case that the printing apparatus 901 includes the color adjustment module, the color adjustment processing unit 904 does not perform the color adjustment processing, and similar to the first embodiment, the intermediate data editing unit 207 generates the print data reflecting the color adjustment settings and transmits the print data to the printing apparatus 102. In this way, in the second embodiment, even in the case that the printing apparatus does not include the color adjustment module, it is possible to provide the user with the color adjustment functions.

Hereinafter, a third embodiment of the present invention will be described.

In the first embodiment, the case has been described in which the printing apparatus 102 including the color adjustment functions is connected to the host computer 101 and all color adjustments are performed by the printing apparatus 102. Furthermore, in the second embodiment, the case has been described in which the printing apparatus 901 not including the color adjustment functions is connected to the host computer 101 and the extended application 902 performs all color adjustments instead of the printing apparatus 901.

On the other hand, in the third embodiment, a case will be described in which a printing apparatus 901′ (a third printing apparatus) including some of the color adjustment functions is connected to the host computer 101.

Like the printing apparatus 901′, there is a case where only some of the color adjustment functions can be implemented. Specifically, the printing apparatus 901′ is capable of performing only the saturation adjustment among the brightness adjustment, the contrast adjustment, the saturation adjustment, and the hue adjustment. In this case, it is also possible to perform all the color adjustment functions by the extended application 902 as in the second embodiment. However, generally, in the case that the printing apparatus includes the color adjustment module, the color adjustment module is configured with the dedicated module capable of high-speed processing, whereas the extended application 902 (the color adjustment processing unit 904) is configured with the general purpose processing module. For this reason, the color adjustment that can be performed by the printing apparatus is likely to be processed faster by the printing apparatus than by the extended application. Therefore, when considering printing performance, it is preferable to perform the color adjustment that can be performed by the printing apparatus 901′ (here, the saturation adjustment) by the printing apparatus 901′.

Therefore, in the third embodiment, a method will be described in which the color adjustment that can be performed by the printing apparatus 901′ is performed by the printing apparatus 901′, and the color adjustment that cannot be performed by the printing apparatus 901′ is performed by the extended application 902.

It should be noted that in the following description, only the difference from the second embodiment will be described. A printing system 1-3 according to the third embodiment differs from the second embodiment in that the printing apparatus 901′ that includes only a saturation adjustment module among the color adjustment modules is connected to the host computer 101. In addition, due to this difference, the sequence after the editing application accepts the print setting also differs from that in the second embodiment (see FIG. 12).

### <Sequence After the Editing Application 201 Accepts Print Setting in the Third Embodiment>

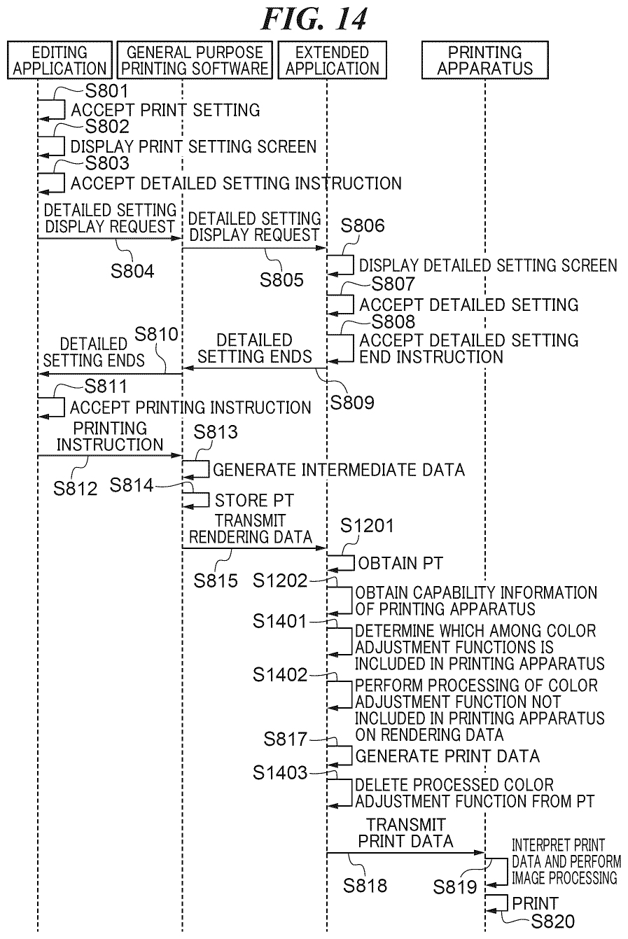

A printing processing according to the third embodiment executed by the editing application 201, the general purpose printing software 202, the extended application 902, and the printing apparatus 901′ after the editing application 201 accepts a print setting will be described with reference to a sequence shown in FIG. 14. It should be noted that respective steps other than respective steps for the printing apparatus 901′ in FIG. 14 are performed by the CPU 111 controlling the editing application 201, the general purpose printing software 202, and the extended application 902. In addition, the respective steps for the printing apparatus 901′ in FIG. 14 are performed by a CPU (not shown) within the printing apparatus 901′. In addition, in FIG. 14, steps having the same reference numerals as those in FIG. 12 are the same processes as those in FIG. 12, and therefore the description thereof will be omitted. In the third embodiment, as an example, a case will be described in which the user selects the brightness adjustment: +1 as the brightness adjustment setting and selects the saturation adjustment: +1 as the saturation adjustment setting on the detailed setting screen and the editing application 201 accepts the print setting.

After the processes of the steps S801 to S815, S1201, and S1202, in a step S1401, the color adjustment processing unit 904 determines, based on the capability information obtained in the step S1202, whether or not the printing apparatus 901′ includes the module related to the color adjustment included in the print setting. Here, specifically, the color adjustment processing unit 904 determines whether or not the printing apparatus 901′ includes the brightness adjustment module and the saturation adjustment module. The printing apparatus 901′ includes the saturation adjustment module but does not include the brightness adjustment module. For this reason, in the case of the third embodiment, it is determined that the printing apparatus 901′ does not include the brightness adjustment module among the modules related to the color adjustment included in the print setting (NO in the step S1401), and the sequence proceeds to a step S1402. On the other hand, it is determined that the printing apparatus 901′ includes the saturation adjustment module among the modules related to the color adjustment included in the print setting (YES in the step S1401), and the sequence proceeds to the step S817.

Next, in the step S1402, the color adjustment processing unit 904 performs the brightness adjustment processing with respect to the rendering data based on the brightness adjustment setting included in the PT obtained in the step S1201, and then stores the adjusted rendering data in the shared information 209. Next, after the print data is generated in the step S817, in a step S1403, the brightness adjustment setting of the PT is edited to “0”. Alternatively, the brightness adjustment setting is deleted from the PT. Thereafter, the sequence proceeds to the step S818 to transmit the print data to the printing apparatus 901′.

By doing the above, even in the case that the printing apparatus 901′ connected to the host computer 101 does not include some of the functions of the color adjustment modules, it is possible to provide the user with the color adjustment functions, and it is also possible to improve the printing performance.

Hereinafter, a fourth embodiment of the present invention will be described.

In the case that a plurality of processes such as the color adjustment functions are combined, it is useful to be able to see the results of the adjustments before printing. Therefore, in the fourth embodiment, a method of previewing the results of the adjustments made in the extended application 902 (here, the results of the color adjustment) before printing will be described.

It should be noted that in the following description, only the difference from the first embodiment will be described. A printing system 1-4 according to the fourth embodiment differs from the first embodiment in that the printing system 1-4 includes the extended application 902 (see FIG. 9) that has an internal configuration different from that of the extended application 204 (see FIG. 2B). In addition, due to this difference, the printing processing after the editing application accepts the print setting also differs from that in the first embodiment (see FIG. 8).

### <Sequence After the Editing Application 201 Accepts Print Setting in the Fourth Embodiment>

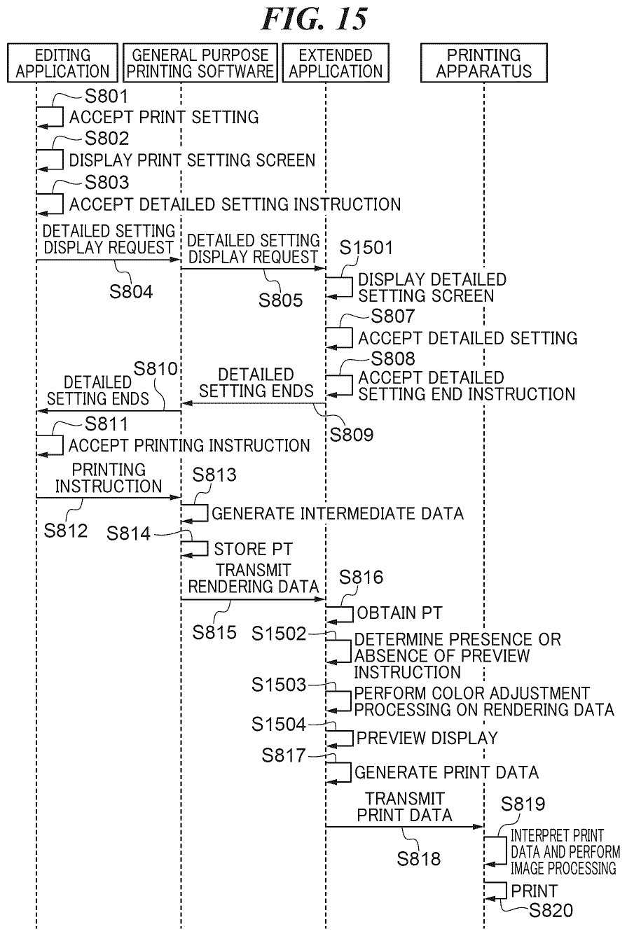

A printing processing according to the fourth embodiment executed by the editing application 201, the general purpose printing software 202, the extended application 902, and the printing apparatus 102 after the editing application 201 accepts a print setting will be described with reference to a sequence shown in FIG. 15. It should be noted that respective steps other than respective steps for the printing apparatus 102 in FIG. 15 are performed by the CPU 111 controlling the editing application 201, the general purpose printing software 202, and the extended application 902. In addition, the respective steps for the printing apparatus 102 in FIG. 15 are performed by the CPU (not shown) within the printing apparatus 102. In addition, in FIG. 15, steps having the same reference numerals as those in FIG. 8 are the same processes as those in FIG. 8, and therefore the description thereof will be omitted.

After the processes of the steps S801 to S805 are ended, in a step S1501,

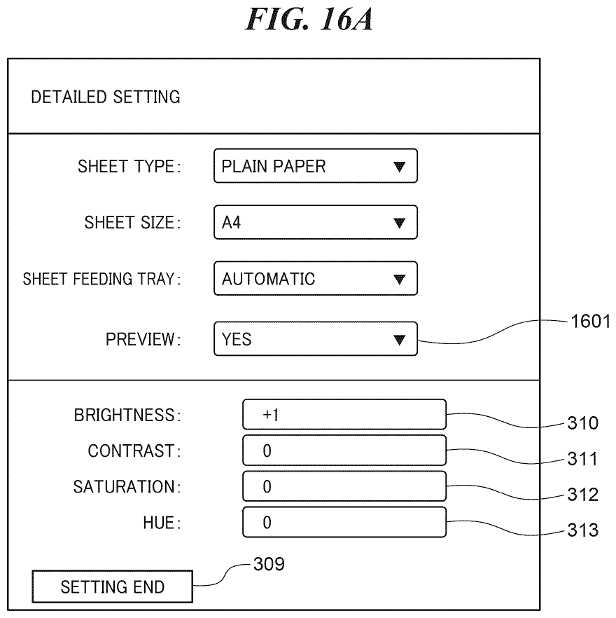

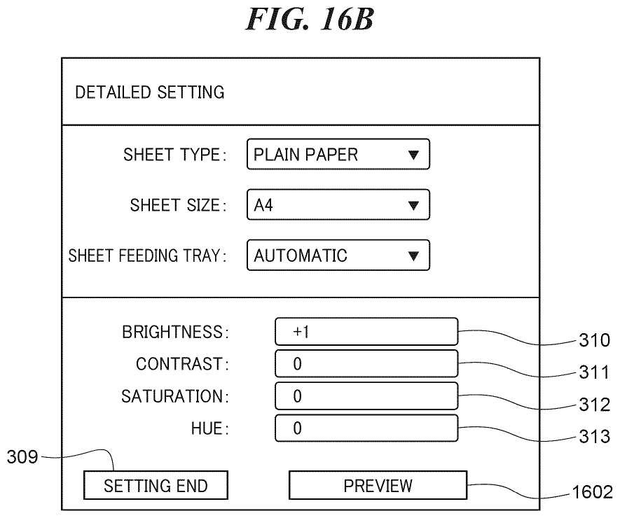

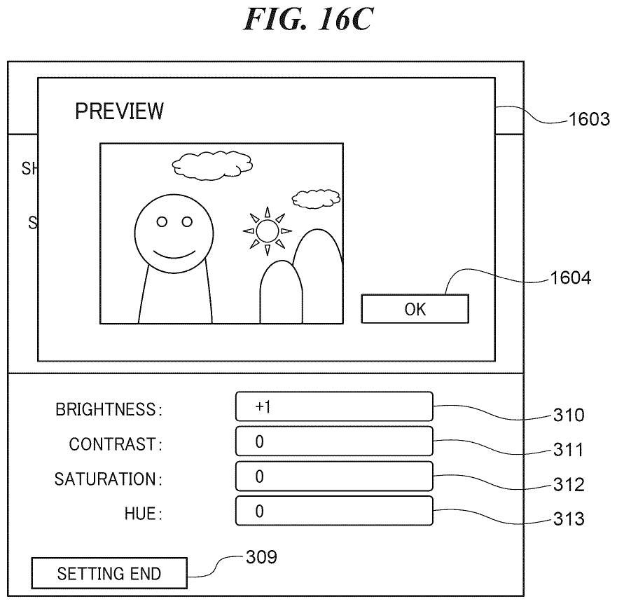

the print setting extending unit 205 of the extended application 902 displays a detailed setting screen shown in FIG. 16A. The detailed setting screen in the fourth embodiment is obtained by adding, to the detailed setting screen 300cshown in FIG. 3C, a control 1601 for selecting whether or not to display a preview. The subsequent steps S807 to S816 are similar to those in the first embodiment, and therefore the description thereof will be omitted.

Next, in a step S1502, the print setting extending unit 205 of the extended application 902 determines whether or not the preview display has been set to “ON” by the control 1601 (see FIG. 16A). In the case that the preview display has been set to “ON” by the control 1601 (YES in the step S1502), the sequence proceeds to a step S1503, and otherwise (NO in the step S1502), the sequence proceeds to the step S817.

In the step S1503, the color adjustment processing unit 904 of the extended application 902 performs the color adjustment processing with respect to the rendering data. Specifically, the color adjustment processing unit 904 performs the color adjustment processing with respect to the rendering data in accordance with the color adjustment settings (here, the brightness adjustment: +1) selected by the user by using the controls 310 to 313 on the detailed setting screen shown in FIG. 16A.

Next, in a step S1504, the print setting extending unit 205 of the extended application 902 displays, on a screen 1603 shown in FIG. 16C, the rendering data after the color adjustment processing is performed in the step S1503. It should be noted that when the user presses an OK button 1604, returning to the original detailed setting screen shown in FIG. 16A. After returning to the original detailed setting screen, in the case that the preview display “ON” has been cancelled by the control 1601 and then the control 309 (a setting end button) is pressed, the sequence proceeds to the step S817.

It should be noted that the printing apparatus 901 may be connected to the host computer 101 instead of the printing apparatus 102. In this case, when it is determined in the step S1502 that the preview display has not been set to “ON”, the same processes as in the second embodiment shown in FIG. 12 are performed. That is, the steps S1202 to S1204 are executed, and the color adjustment processing unit 904 of the extended application 902 performs the color adjustment according to the capability information and the like.

In addition, the printing apparatus 901′ may be connected to the host computer 101 instead of the printing apparatus 102. In this case, when it is determined in the step S1502 that the preview display has not been set to “ON”, the same processes as in the third embodiment shown in FIG. 15 are performed. That is, the steps S1202, S1401, S1402, and S1403 are executed, and the color adjustment processing unit 904 of the extended application 902, or the printing apparatus 901′ performs the color adjustment according to the capability information and the like. It should be noted that in this case, in the case that the preview display has been set to “ON” in the step S1502, the color adjustment (the saturation adjustment in the third embodiment) performed by the printing apparatus 901′ is also included in the color adjustment in the step S1503.

It should be noted that in the fourth embodiment, although the preview display is displayed on a separate screen, the preview display may be incorporated in the detailed setting screen, and any format may be used as long as the preview display is possible. In addition, in the fourth embodiment, although the control 1601 is used to switch the presence or absence of the preview display (switch between turning on and turning off the preview display, the processes of the steps S807 to S1504 may be performed when a preview button 1602 shown in FIG. 16B is pressed.

By doing the above, it is possible to preview the rendering data after the color adjustment in the extended application 902, and hence it is possible to confirm the results of the color adjustment before printing.

It should be noted that, in the embodiments of the present invention, it is also possible to implement processing in which a program for implementing one or more functions is supplied to a computer of a system or an apparatus via a network or a storage medium, and a system control unit of the system or the apparatus reads out and executes the program. The system control unit may include one or more processors or circuits, and in order to read out and execute executable instructions, the system control unit may include multiple isolated system control units or a network of multiple isolated processors or circuits.

The processor or circuit may include a central processing unit (CPU), a micro processing unit (MPU), a graphics processing unit (GPU), an application-specific integrated circuit (ASIC), and/or a field-programmable gate array (FPGA). In addition, the processor or circuit may include a digital signal processor (DSP), a data flow processor (DFP), or a neural processing unit (NPU).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-134130, filed on Aug. 21, 2023, which is hereby incorporated by reference herein in its entirety.

What is claimed is:

1. A non-transitory computer readable storage medium storing an application program that supports general purpose printing software capable of generating print data printable by printing apparatuses provided by a plurality of manufacturers and causing to transmit the generated print data to the printing apparatus, the application program being executed by an information processing apparatus so that a control method is executed,
the control method comprising:
causing the information processing apparatus to display a screen that accepts settings for color adjustments from a user; and
causing the printing apparatus to execute color adjustments of print data generated by the general purpose printing software based on the settings that have been accepted via the screen.

2. The non-transitory computer readable storage medium according to claim 1, wherein
the control method further comprises determining whether or not the printing apparatus is capable of executing the color adjustments,
in a case of being determined that the printing apparatus is capable of executing the color adjustments, the color adjustments are executed by the printing apparatus based on the settings that have been accepted via the screen, and
in a case of being determined that the printing apparatus is not capable of executing the color adjustments, the color adjustments are executed by the information processing apparatus based on the settings that have been accepted via the screen.

3. The non-transitory computer readable storage medium according to claim 1, wherein
the control method further comprises
causing the information processing apparatus to obtain capability information of the printing apparatus; and
identifying color adjustment functions capable of being executed by the printing apparatus based on the obtained capability information,
among settings that have been accepted on the screen, color adjustments capable of being executed by color adjustment functions that have not been identified based on the capability information are executed by the information processing apparatus based on the settings that have been accepted via the screen, and
among the settings that have been accepted on the screen, color adjustments capable of being executed by color adjustment functions that have been identified based on the capability information are executed by the printing apparatus based on the settings that have been accepted via the screen.

4. The non-transitory computer readable storage medium according to claim 1, wherein
the control method further comprises
causing the information processing apparatus to display an image after the color adjustments based on settings that have been accepted on the screen have been performed.

5. The non-transitory computer readable storage medium according to claim 1, wherein
the setting for the color adjustment is performed by selecting a numerical value.

6. The non-transitory computer readable storage medium according to claim 1, wherein
the setting for the color adjustment is performed by moving a slide bar.

7. The non-transitory computer readable storage medium according to claim 1, wherein
the setting for the color adjustment is performed by moving a pointer.

8. The non-transitory computer readable storage medium according to claim 1, wherein
the color adjustments include a brightness adjustment, a contrast adjustment, a saturation adjustment, and a hue adjustment.

9. A non-transitory computer readable storage medium storing an application program that supports general purpose printing software capable of generating print data printable by printing apparatuses provided by a plurality of manufacturers and causing to transmit the generated print data to the printing apparatus, the application program being executed by an information processing apparatus so that a control method is executed,
the control method comprising:
causing the information processing apparatus to display a screen that accepts settings for color adjustments from a user; and
causing the information processing apparatus to execute color adjustments of print data generated by the general purpose printing software based on the settings that have been accepted via the screen.

10. A control method executed by an information processing apparatus executing an application program that supports general purpose printing software capable of generating print data printable by printing apparatuses provided by a plurality of manufacturers and causing to transmit the generated print data to the printing apparatus,
the control method comprising:
causing the information processing apparatus to display a screen that accepts settings for color adjustments from a user; and
causing the printing apparatus to execute color adjustments of print data generated by the general purpose printing software based on the settings that have been accepted via the screen.

11. An information processing apparatus including general purpose printing software that is capable of generating print data printable by printing apparatuses provided by a plurality of manufacturers and causing to transmit the generated print data to the printing apparatus, and an application program that supports the general purpose printing software,
the information processing apparatus comprising:
a display unit configured to display a screen a screen that accepts settings for color adjustments from a user by executing the application program; and
a control unit configured to cause the printing apparatus to execute color adjustments of print data generated by the general purpose printing software based on the settings that have been accepted via the screen.
